(19) United States
(12) Patent Application Publication
(10) Pub. No.: US 2025/0358508 A1
(43) Pub. Date: Nov. 20, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUKI YOSHIMURA, Tokyo (JP)

(21) Appl. No.: 19/280,528

(22) Filed: Jul. 25, 2025

Related U.S. Application Data
(63) Continuation of application No. PCT/JP2024/000940, filed on Jan. 16, 2024.

(30) Foreign Application Priority Data
Feb. 21, 2023 (JP) 2023-025527

(51) Int. Cl. H04N 23/60; G06T 7/00; H04N 23/63

(52) U.S. Cl. CPC H04N 23/64; G06T 7/0002; H04N 23/632; G06T 2207/30168

(57) ABSTRACT

An information processing apparatus includes a first acquiring unit configured to acquire a plurality of images respectively obtained by a plurality of image capturing devices, a second acquiring unit configured to acquire, for each of the plurality of images, a visual-quality evaluation value indicating a degree of visual quality of the image, and a selecting unit configured to select one or more candidate images from among the plurality of images based on the visual-quality evaluation value, the one or more candidate images each being a candidate of an image to be used for viewing.

### CROSS-REFERENCE TO RELATED APPLICATIONS

This application is a Continuation of International Patent Application No. PCT/JP2024/000940, filed Jan. 16, 2024, which claims the benefit of Japanese Patent Application No. 2023-025527, filed Feb. 21, 2023, both of which are hereby incorporated by reference herein in their entirety.

### BACKGROUND

### Field of the Technology

The present disclosure relates to an information processing apparatus that processes image information obtained from a plurality of image capturing devices.

### Description of the Related Art

Conventionally, in a case in which live streaming is performed using a camera system formed from a plurality of cameras, the image viewed by viewers is typically an image that has been selected and edited by an operator operating the camera system before being streamed. This is because, even if selection is simply performed in a mechanical manner from among images shot using the plurality of cameras and the selected image is live-streamed, it is difficult to provide an image with good visual quality to viewers.

In addition, not much consideration is given to the visual quality of the images themselves in the conventional method of selecting an image from the plurality of cameras, and the method of evaluating subject state and selecting the primary subject from among a plurality of subjects present in the images is mainstream. Thus, in most camera systems, it is assumed that the operation of selecting an image to be streamed to viewers from among the images shot using the plurality of cameras will be performed manually, and thus a system configuration relying on operator skill is adopted.

For example, Japanese Patent Laid-Open No. 2008-148330 discloses an image capturing apparatus that concurrently shoots images of the same subject using a plurality of cameras, evaluates subject state based on a predetermined criterion, and displays the images with priorities assigned thereto based on the evaluation.

However, in the image capturing apparatus disclosed in Japanese Patent Laid-Open No. 2008-148330, no consideration is given to how an image with good visual quality from the perspective of viewers can be selected in a case in which images of different subjects are shot using a plurality of cameras; thus, it would be difficult to apply the image capturing apparatus disclosed in Japanese Patent Laid-Open No. 2008-148330 to the automation of image selection in a camera system.

### SUMMARY

The present disclosure has been made in view of the above-described problem, and provides an information processing apparatus that can automatically select an image to be streamed to viewers from among a plurality of images shot using different cameras.

An information processing apparatus according to the present disclosure comprising: at least one processor or circuit and a memory storing instructions to cause the at least one processor or circuit to perform operations of the following units: a first acquiring unit configured to acquire a plurality of images respectively obtained by a plurality of image capturing devices; a second acquiring unit configured to acquire, for each of the plurality of images, a visual-quality evaluation value indicating a degree of visual quality of the image; and a selecting unit configured to select one or more candidate images from among the plurality of images based on the visual-quality evaluation value, the one or more candidate images each being a candidate of an image to be used for viewing.

Features of the present disclosure will become apparent from the following description of embodiments with reference to the attached drawings.

### BRIEF DESCRIPTION OF DRAWINGS

FIG. 1 is a block diagram illustrating a configuration of an image capturing apparatus according to a first embodiment of the present disclosure.

FIG. 2 is a diagram illustrating an image-sensor pixel array.

FIG. 3A is a diagram illustrating an image-sensor pixel structure.

FIG. 3B is a diagram illustrating the image-sensor pixel structure.

FIG. 4 is a diagram describing the correspondence between an image-sensor pixel and pupil intensity distributions.

FIG. 5 is a diagram illustrating a camera system including a plurality of cameras.

FIG. 6A is a diagram illustrating a method for quantifying visual quality.

FIG. 6B is a diagram illustrating the method for quantifying visual quality.

FIG. 7 is a diagram illustrating a method for comparing and ranking visual quality of a plurality of cameras.

FIG. 8A is a diagram describing a method for presenting ranked visual-quality evaluation values.

FIG. 8B is a diagram describing a method for presenting ranked visual-quality evaluation values.

FIG. 8C is a diagram describing a method for presenting ranked visual-quality evaluation values.

FIG. 9A is a flowchart illustrating an operation for presenting ranked visual-quality evaluation values.

FIG. 9B is a flowchart illustrating an operation for automatically selecting an image to be streamed to viewers.

FIG. 10A is a diagram illustrating an example in which a composition is changed in automatic shooting according to a second embodiment.

FIG. 10B is a diagram illustrating an example in which a composition is changed in the automatic shooting according to the second embodiment.

FIG. 10C is a diagram illustrating an example in which a composition is changed in the automatic shooting according to the second embodiment.

FIG. 11 is a diagram illustrating an example of a camera layout for realizing the automatic shooting according to the second embodiment.

FIG. 12 is a flowchart illustrating an automatic shooting operation in the second embodiment in which the visual-quality evaluation values are used.

FIG. 13 is a diagram illustrating an example in a third embodiment in which the visual-quality evaluation values are recorded in temporal association with images.

FIG. 14 is a flowchart illustrating an operation for recording the visual-quality evaluation values in association with images.

FIG. 15 is a flowchart illustrating an operation for automatically editing a highlight-scene video.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a case will be described in which an information processing apparatus according to the present disclosure is applied to an image capturing apparatus such as a digital camera; however, the present disclosure is widely applicable to apparatuses other than image capturing apparatuses, such as display apparatuses, distance detection apparatuses, and electronic apparatuses.

### [Overall Configuration]

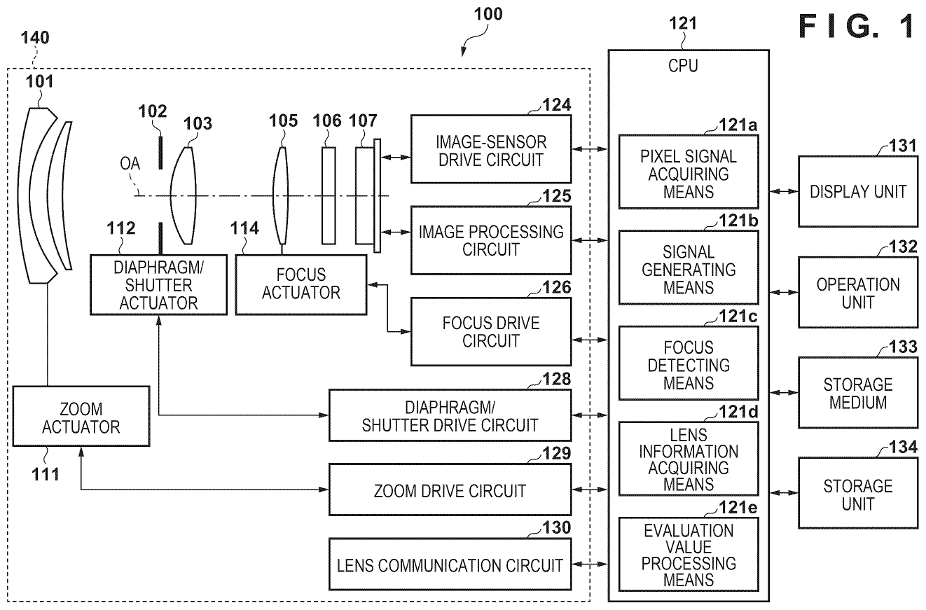

FIG. 1 is a block diagram illustrating a configuration of an image capturing apparatus 100 according to a first embodiment of the present disclosure. The image capturing apparatus 100 is a digital camera system including a camera main body and an interchangeable lens (imaging optical system or image capturing optical system) that is detachably attached to the camera main body. However, the present disclosure is not limited to this, and is also applicable to an image capturing apparatus in which a camera main body and a lens are integrally formed.

The imaging optical system (image capturing optical system) condenses light from a subject and images the light as a subject image (optical image) on a predetermined imaging plane. A first lens group 101 is disposed frontmost (on the subject side) among a plurality of lens groups constituting the imaging optical system, and is held by a lens barrel so as to be capable of moving forward and backward along an optical axis OA. A diaphragm/shutter (diaphragm) 102 adjusts the light amount during capturing of an image by the aperture diameter thereof being adjusted, and also functions as an exposure-time adjustment shutter during capturing of a still image. A second lens group 103 moves forward and backward along the optical axis OA integrally with the diaphragm/shutter 102, and has a zoom function for performing a zooming operation in tandem with the forward and backward movement of the first lens group 101. A third lens group 105 is a focus lens group that performs focal point adjustment (focus operation) by moving forward and backward along the optical axis OA. An optical low-pass filter 106 is an optical element for reducing false colors and moiré in a captured image.

An image sensor 107 is formed from a CMOS sensor or a CCD sensor, and a peripheral circuit thereof, for example, and performs photoelectric conversion of the subject image. As the image sensor 107, a two-dimensional single-plate color sensor in which on-chip primary color mosaic filters are formed in a Bayer array on light receiving pixels including m pixels in the horizontal direction and n pixels in the vertical direction is used, for example. The image capturing optical system and the image sensor 107 form one image capturing unit; however, there is no limitation to a single-sensor system such as that disclosed in the present embodiment, and a three-sensor system may be adopted, for example. Furthermore, a configuration including a plurality of image capturing units may be adopted. That is, the present disclosure is applicable to any configuration in which a corresponding image capturing optical system is included for each image sensor.

During a zooming operation, a zoom actuator 111 turns a cam cylinder (unillustrated) and thereby moves the first lens group 101 and the second lens group 103 along the optical axis OA. During the adjustment of light amount (image capturing light amount), a diaphragm/shutter actuator 112 adjusts the aperture diameter of the diaphragm/shutter 102. During the focal point adjustment, a focus actuator 114 moves the third lens group 105 along the optical axis OA. Note that the same component does not necessarily have to be used as the diaphragm and the shutter, and a configuration in which a diaphragm and a shutter are separately provided may be adopted.

A CPU 121 is a control device (controller) that governs various types of control of the image capturing apparatus 100. The CPU 121 includes a processor, a ROM, a RAM, an A/D converter, a D/A converter, a communication interface circuit, etc. By reading out and executing a predetermined program stored in the ROM or the RAM, the CPU 121 drives various circuits in the image capturing apparatus 100 to control a series of operations such as focus detection (AF), image capturing, image processing, or recording. Furthermore, some functions of the CPU 121 may be implemented as hardware circuits, and reconfigurable circuits such as FPGAs may be used for some of the circuits. For example, part of the processing for the later-described focus detection may be performed using a dedicated hardware circuit to reduce processing time.

Furthermore, the CPU 121 includes pixel signal acquiring means 121a, signal generating means 121b, focus detecting means 121c, lens information acquiring means 121d, and evaluation value processing means 121e. Such means are typically realized by the CPU 121 reading out and executing the predetermined program stored in the ROM or the RAM.

Furthermore, not only a system in which the communication interface circuit included in the CPU 121 is connected to external apparatuses via a wired cable such as a USB cable or a LAN cable, but also a system in which the communication interface circuit is connected to external apparatuses via wireless communication such as wireless LAN or a mobile network may be adopted. Furthermore, the method of communication with a communication counterpart is not limited to a connection method in which direct connection with a personal computer or a smartphone is established, and may be a method in which connection with a proximate or remote device is established via an access point and/or a network.

An image-sensor drive circuit 124 controls the image capturing operation of the image sensor 107, and also subjects an acquired image signal to A/D conversion and transmits the converted image signal to the CPU 121. An image processing circuit 125 performs, on image data output from the image sensor 107, processing such as gamma conversion, color interpolation, or Joint Photographic Experts Group (JPEG) compression.

Based on a focus detection result from the focus detecting means 121c, etc., a focus drive circuit 126 performs focus adjustment by driving the focus actuator 114 and moving the third lens group 105 along the optical axis OA. A diaphragm/shutter drive circuit 128 drives the diaphragm/shutter actuator 112 to control the aperture diameter of the diaphragm/shutter 102 and also control exposure time during capturing of a still image. In accordance with a zoom operation performed by an image capturer, a zoom drive circuit 129 performs a zooming operation by driving the zoom actuator 111 and moving the first lens group 101 and the second lens group 103 along the optical axis OA.

A lens communication circuit 130 communicates with the interchangeable lens attached to the camera main body to acquire lens information of the interchangeable lens and set various focus detection correction values. The acquired lens information is output to the lens information acquiring means 121d of the CPU 121. Furthermore, a configuration may be adopted in which image capture information, etc., detected by the camera main body is transmitted to the interchangeable lens. The interchangeable lens and the camera main body are configured so as to be coupled to one another by bayonet coupling via a mount, and such that multiple terminals thereof contact one another in the coupled state.

The term “image capturing optical system 140” is used to collectively refer to the first lens group 101, the diaphragm/shutter (diaphragm) 102, the second lens group 103, the third lens group 105, the optical low-pass filter 106, the zoom actuator 111, the diaphragm/shutter actuator 112, the focus actuator 114, the focus drive circuit 126, the diaphragm/shutter drive circuit 128, the zoom drive circuit 129, and the lens communication circuit 130, which constitute the imaging optical system, and the image sensor 107, the image-sensor drive circuit 124, and the image processing circuit 125, which constitute the image capturing system.

A display unit 131 is formed to include a liquid crystal display (LCD), for example. The display unit 131 displays information relating to the image capturing mode of the image capturing apparatus 100, a preview image displayed before an image is captured, a confirmation image displayed after an image is captured, or an in-focus state display image displayed during focus detection. An operation unit 132 is formed to include a power switch, a release switch, a zoom operation switch, an image-capturing-mode selection switch, etc. The release switch includes switches for two stages, namely a half-pressed state (SW1 is on) and a fully pressed state (SW2 is on). A recording medium 133 is, for example, a flash memory that is detachable from the image capturing apparatus 100, and records captured images (image data). A storage unit 134 stores captured images, etc., in predetermined formats.

Note that a configuration may be adopted in which some functions of the operation unit 132 are provided to the display unit 131 in the form of a touch panel or the like. This makes it possible to perform focus detection with respect to a desired position in a preview image by operating the touch panel while the image is being displayed on the display unit 131.

Note that a configuration may be adopted such that an unillustrated TVAF unit is provided, and contrast-detection-type focus detection processing is performed based on generated TVAF evaluation values (image-data contrast information). When the contrast-detection-type focus detection processing is performed, the focus lens group 105 is moved, and a lens position at which a peak evaluation value (focus evaluation value) is obtained is detected as the in-focus position.

In such a manner, the image capturing apparatus 100 according to the present embodiment is capable of executing image-capturing-plane phase-difference detection AF and TVAF in combination, and can use such AF methods selectively or in combination in accordance with the situation. These blocks function as controlling means for controlling the position of the focus lens group 105 using the respective focus detection results.

### [Image Sensor]

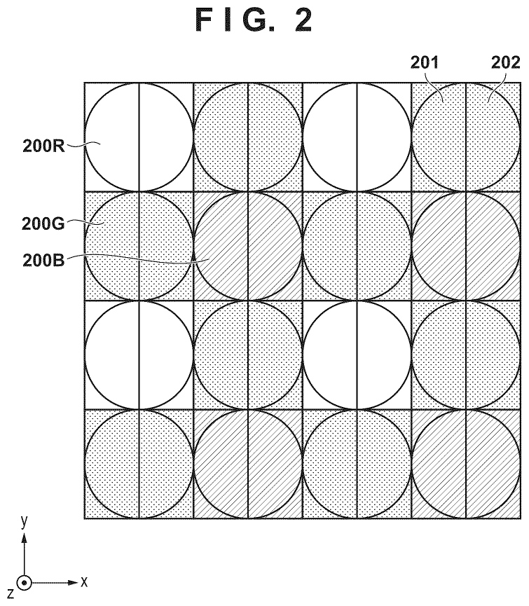

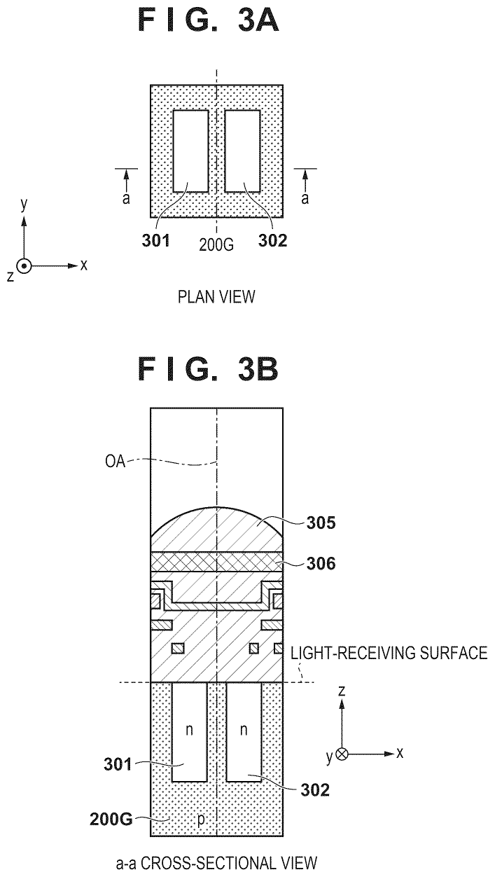

With reference to FIG. 2 and FIGS. 3A and 3B, a pixel array and a pixel structure in the image sensor 107 in the present embodiment will be described. FIG. 2 is a diagram illustrating an array of pixels (image capturing pixels) in the image sensor 107. FIGS. 3A and 3B are diagrams illustrating a pixel structure in the image sensor 107, FIG. 3A being a plan view (from the +z direction) of a pixel 200G in the image sensor 107 and FIG. 3B being a cross-sectional view taken along line a-a in FIG. 3A.

FIG. 2 illustrates an array of pixels in the image sensor 107 within a 4×4 (column×row) area. In the present embodiment, in a 2×2 (column×row) pixel group 200, pixels 200R, 200G, and 200B are disposed in a Bayer array. Specifically, in the pixel group 200, a pixel 200R having a spectral sensitivity of red (R) is disposed at the upper left, pixels 200G having a spectral sensitivity of green (G) are disposed at the upper right and the lower left, and a pixel 200B having a spectral sensitivity of blue (B) is disposed at the lower right. Each of the pixels 200R, 200G, and 200B is formed from a focus detection pixel (first focus detection pixel) 201 and a focus detection pixel (second focus detection pixel) 202 that are disposed in a 2×1 (column×row) array. Thus, FIG. 2 illustrates an array of focus detection pixels within an 8×4 (column×row) area. Note that, while each pixel in the present embodiment is formed from two focus detection pixels disposed in the x direction, there is no limitation to this; that is, the focus detection pixels may be disposed in the y direction. Furthermore, each pixel may be formed from two or more focus detection pixels, and a configuration obtained by combining some configurations may be adopted.

As illustrated in FIG. 2, the image sensor 107 is formed by disposing a large number of pixels forming 4×4 (column×row) arrays (focus detection pixels forming 8×4 (column×row) arrays) on a surface, and outputs an image capturing signal (focus detection signal). In the image sensor 107 according to the present embodiment, the pixel pitch P is 6 μm, and the pixel count Nis 6,000×4,000 (horizontal columns×vertical rows)=24 million pixels. Furthermore, in the image sensor 107, the column-direction pitch PSUB of focus detection pixels is 3 μm, and the focus detection pixel count NSUB is 12,000×4,000 (horizontal columns×vertical rows)=48 million pixels. If a 4K-format video or the like is to be acquired using the image sensor 107, it is desirable that the image sensor 107 include 4,000 horizontal columns or more of pixels. Furthermore, if an image in a format having a size greater than this is to be acquired, it is desirable that the image sensor 107 be provided with a pixel count corresponding to the format.

As illustrated in FIG. 3B, each pixel 200G according to the present embodiment includes a microlens 305 for condensing incident light to the side of the light-receiving surface, which is an interface of a semiconductor, such as silicon, in which pixel photodiodes are formed. A plurality of the microlenses 305 are two-dimensionally arrayed, and disposed at positions that are located at a predetermined distance from the light-receiving surface in the z-axis direction (direction of optical axis OA). Furthermore, in each pixel 200G, a photoelectric conversion unit 301 and a photoelectric conversion unit 302 are formed, the photoelectric conversion units being provided in a quantity indicated by a division count NLF=Nx×Ny (division count=2) obtained by performing division by Nx (division by 2) in the x direction and division by Ny (division by 1) in the y direction. The photoelectric conversion unit 301 and the photoelectric conversion unit 302 respectively correspond to a focus detection pixel 201 and a focus detection pixel 202.

The photoelectric conversion units 301 and 302 are formed on a semiconductor substrate made from silicon or the like, and are each formed as a pn junction photodiode formed from a p-type layer and an n-type layer. The photoelectric conversion units 301 and 302 may each be formed as a pin-structure photodiode in which an intrinsic layer is sandwiched between the p-type and n-type layers, as necessary. In each pixel 200G (in each pixel), a color filter 306 is provided between the microlens 305 and the photoelectric conversion units 301 and 302. As necessary, the spectral transmittance of the color filter 306 can be varied between individual pixels or individual photoelectric conversion units, or the color filter may be omitted.

Light incident on a pixel 200G is received by the photoelectric conversion units 301 and 302 after being condensed by the microlens 305 and being spectrally separated by the color filter 306. In the photoelectric conversion units 301 and 302, electron-hole pairs are generated in accordance with the received light amount, and the electrons (negative charge) are accumulated in the n-type layer after the electrons and holes are separated in a depletion layer. On the other hand, the holes are discharged to the outside of the image sensor 107 through the p-type layer, which is connected to a constant voltage source (unillustrated). The electrons accumulated in the n-type layers of the photoelectric conversion units 301 and 302 are transferred to an electrostatic capacitance section (FD) through a transfer gate to be converted into a voltage signal.

Note that, in the present embodiment, the microlens 305 corresponds to an optical system in the image sensor 107. The optical system may be configured to include a plurality of microlenses, or may be configured as a waveguide, etc., in which materials having different refractive indices are used. Furthermore, the image sensor 107 may be a backside-illuminated image sensor including one or more circuits, etc., on the surface on the reverse side from the surface on which the microlenses 305 are included, or may be a stacked image sensor further including some circuits such as the image-sensor drive circuit 124 and the image processing circuit 125. Furthermore, a material other than silicon may be used as the semiconductor substrate, and an organic material, for example, may be used as the photoelectric conversion material.

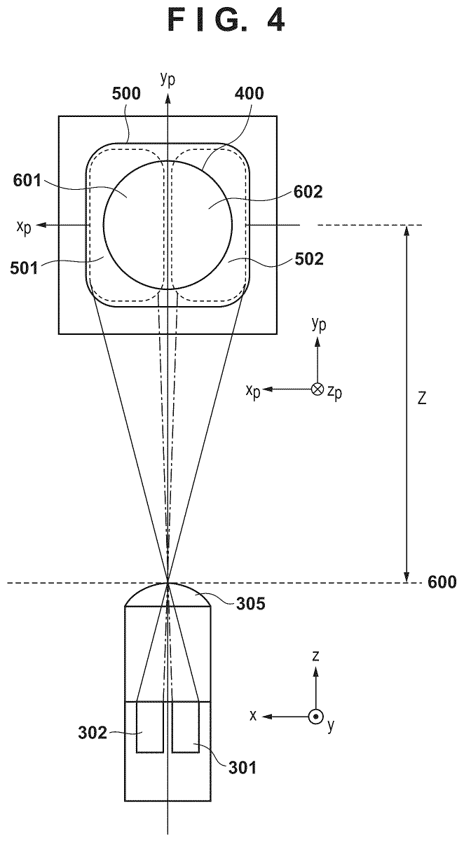

FIG. 4 illustrates: a cross-sectional view in which the a-a cross-section of a pixel 200G arrayed in the image sensor 107 according to the present embodiment illustrated in FIG. 3A is viewed from the +y side; and a pupil plane in a position that is located at a distance Z from an image capturing plane 600 of the image sensor 107 in the z-axis direction (direction of optical axis OA). Note that, in FIG. 4, for consistency with the coordinate axes of the exit pupil plane, the x and y axes of the cross-sectional diagram are reversed from those in FIGS. 3A and 3B. The image capturing plane 600 of the image sensor 107 is positioned at the imaging plane of the imaging optical system.

A pupil intensity distribution (first pupil intensity distribution) 501 is in a substantially conjugate relationship with the light receiving plane of the photoelectric conversion unit 301, whose center of gravity is decentered in the −x direction, with the microlens 305 therebetween. Thus, the first pupil intensity distribution 501 corresponds to a pupil area in which light can be received by the focus detection pixel 201. The center of gravity of the first pupil intensity distribution 501 is decentered toward the +xp side on the pupil plane. Similarly, a pupil intensity distribution (second pupil intensity distribution) 502 is in a substantially conjugate relationship with the light receiving plane of the photoelectric conversion unit 302, whose center of gravity is decentered in the +x direction, with the microlens 305 therebetween. Thus, the second pupil intensity distribution 502 corresponds to a pupil area in which light can be received by the focus detection pixel 202. The center of gravity of the second pupil intensity distribution 502 is decentered toward the −xp side on the pupil plane. Furthermore, a pupil intensity distribution 500 is a pupil area in which light can be received by the entire pixel 200G obtained by combining the photoelectric conversion units 301 and 302 (focus detection pixels 201 and 202) entirely. That is, the first pupil intensity distribution 501 is decentered toward the +xp side on the pupil plane from the center of the pupil intensity distribution 500, and the second pupil intensity distribution 502 is decentered toward the −xp side on the pupil plane from the center of the pupil intensity distribution 500.

As described above, in the present embodiment, phase-difference information is acquired by using the above-described image sensor and performing correlation calculation on output signals from the focus detection pixels 201 and 202. Furthermore, a defocus amount is calculated by using the calculated phase-difference information and a known defocus-amount conversion coefficient for converting phase-difference information into a defocus amount (focal-position deviation amount). Focus detection can thus be performed.

Furthermore, in the present embodiment, a case is described in which a 2×1 pupil division is applied to image-sensor pixels as illustrated in FIGS. 3A and 3B, and FIG. 4. However, a y-direction pupil division may be applied, rather than an x-direction pupil division as illustrated in FIGS. 3A and 3B. Furthermore, both x-direction and y-direction pupil division may be applied.

Furthermore, in the present embodiment, a structure has been described in which phase-difference information can be acquired by a single pixel, as illustrated in FIGS. 3A and 3B, and FIG. 4. However, a structure may be adopted in which a pixel that can acquire the pupil intensity distribution 501 and a pixel that can acquire the pupil intensity distribution 502 are separated. Specifically, a half-open light-blocking layer is provided between the light-receiving surface and the microlens 305 in FIGS. 3A and 3B, and a pixel that can acquire the pupil intensity distribution 501 and a pixel that can acquire the pupil intensity distribution 502 are separately provided. Furthermore, phase-difference information is acquired using a pair of corresponding pixels.

Furthermore, in the present embodiment, a structure in which the image sensor can independently detect the focal point has been described to facilitate understanding of the description. However, the above-described image-sensor configuration does not necessarily have to be adopted, as long as focal-point adjustment can be performed. For example, in a case in which phase-difference information cannot be acquired by the image sensor, focus detection according to the contrast-detection method, in which subject contrast is used, may be performed. Alternatively, focus detection may be performed by using dedicated means for focus detection (means such as LIDAR for measuring distance by projecting light to a subject and detecting the reflection thereof) to measure the distance to the subject.

[Problem with Automation in Conventional Camera Systems]

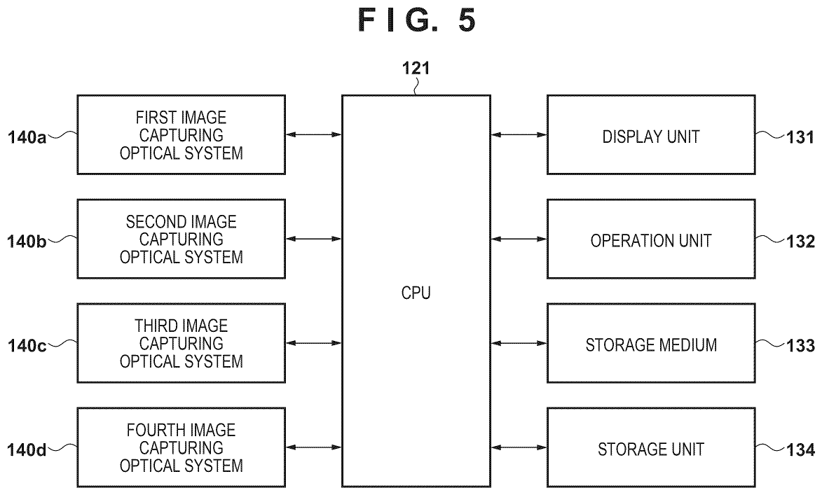

The image capturing apparatus illustrated in FIG. 1 has a configuration in which one image capturing optical system 140 is included; in comparison, FIG. 5 illustrates a configuration of an image capturing system including a plurality of image capturing optical systems 140a to 140d.

Due to the advancement of communication network technology, recent years have seen environments being developed in which live videos of sport competitions and natural scenery shot using a camera system including a plurality of cameras can be easily viewed. In the streaming of such a live video, a streaming provider appropriately selects a video with good visual quality from among videos shot by the plurality of image capturing optical systems illustrated in FIG. 5, and provides the selected video to viewers. Furthermore, there also is a service in which highlight scenes are extracted from images shot during live streaming and edited so that users who could not view the live streaming in real time can later view highlights that he/she has missed.

The main tasks of a live streaming provider are to perform shooting using cameras and select the image to be provided to viewers. The process until an image to be viewed by viewers is determined is as follows. First, from their respective positions, a plurality of camera photographers each select subjects, and adjust the angle of view and focus, and also exposure as necessary, in order to shoot a scene with good visual quality. Subsequently, a selector who determines an image to be provided to viewers checks the plurality of images shot by the photographers and finally selects an appropriate image. An image to be viewed by viewers is determined through such a process. Thus, a live video provider needs to determine in real time an image desired by viewers, and perform shooting and selection from among shot images.

In the shooting of images using cameras and the selection of the image to be provided to viewers during live streaming, it is important that an image desired by viewers be shot and provided. In a conventional primary subject selection method widely used in camera autofocus technology, the primary subject is selected under conditions in which visual quality is not particularly taken into consideration, such as selecting a subject that is present near the screen center, a subject that is closest in terms of distance, or a subject that is similar to a pre-registered image. The conventional primary subject selection method lacks the idea of selecting a subject with good visual quality desired by viewers as the primary subject; thus, it is difficult to apply the conventional primary subject detection technique to the automatic selection of an image to be provided in live streaming. Furthermore, workers are required to be skilled and manual workload is high in sports video streaming because the photographers and the live streaming provider need to make decisions based on future predictions.

Another task required of the live streaming provider is the editing and provision of a highlight-scene image. There are broadly two types of work methods. In one method (hereinafter “streamed image editing”), only the streamed image is edited, whereas, in the other method (hereinafter “all shot image editing”), all image data shot using the plurality of cameras, including images that were not streamed, is edited. In streamed image editing, because highlight scenes have already been extracted and edited to some extent, the workload of subsequent editing is low. On the other hand, there is a problem that, even if scenes with better visual quality have been shot, such scenes cannot be extracted. In all shot image editing, workload is high because highlight scenes need to be edited from scratch. On the other hand, short scenes with better visual quality that could not be provided during streaming can be selected.

The demand for the creation of highlight scenes by all shot image editing is also high because, in highlight-scene video streaming, short scenes with good visual quality are required, and, in many cases, it is also required that editing be performed from a perspective different from that during live streaming.

However, there is a problem with the creation of highlight-scene videos by all shot image editing in that, because it was conventionally difficult to quantify visual quality in accordance with the purpose of shooting, the hurdle for constructing an automatic editing system was high and editing had to be done by human hands.

[Quantification of Visual Quality in Accordance with Shooting Scene]

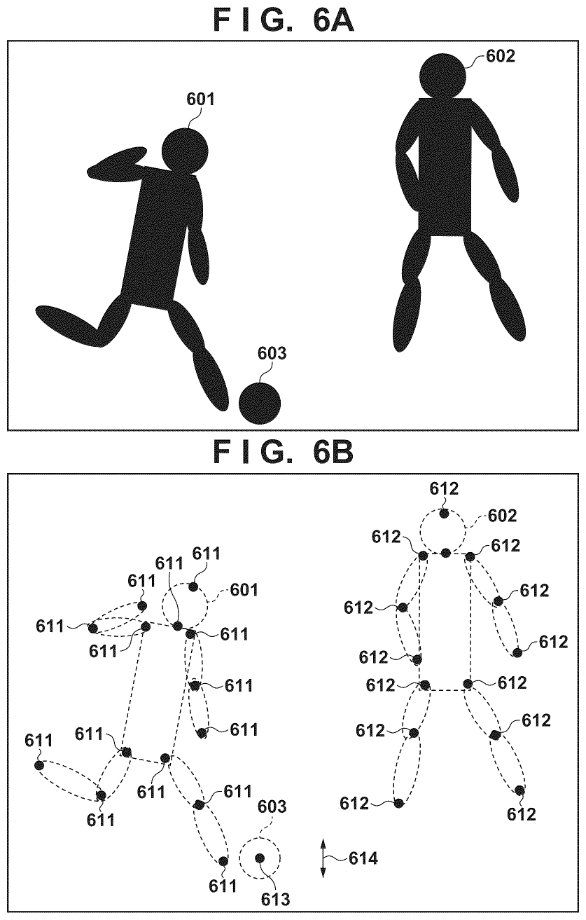

FIGS. 6A and 6B are conceptual diagrams of a method for calculating visual quality as an evaluation value by estimating human posture and also including the positional relationship with a specific object. FIG. 6A illustrates a processing-target image. A subject 601 is about to kick a ball 603. The subject 601 is an important subject in the shooting scene. In the present embodiment, the primary subject is determined using subject posture information and information about a specific object. On the other hand, a subject 602 is a non-primary subject. Herein, a non-primary subject refers to a subject other than the primary subject.

FIG. 6B is a diagram illustrating posture information of the subjects 601 and 602, and also information about the position and size of the ball 603. Joints 611 and joints 612 respectively indicate joints of the subject 601 and joints of the subject 602. FIG. 6B illustrates a case in which the positions of the top of the head, neck, shoulders, elbows, wrists, lower back, knees, and ankles are acquired as joint positions; however, the joint positions may be a subset of such positions, or other positions may be acquired. Furthermore, not only joint positions but also information about axes connecting joints with one another may be used; that is, as long as the information indicates subject posture, any information may be used as posture information. In the following, a case will be described in which joint positions are acquired as posture information.

In order to estimate and calculate human posture as an evaluation value, first, a specific object (object of a predetermined type) in an image is detected, and the two-dimensional coordinates and size of the specific object in the image are acquired. The type of specific object to be detected is determined based on the shooting scene in the image. In the present embodiment, it is assumed that the shooting scene is a ball game; thus, a ball is detected as the specific object.

Subsequently, a subject (person) in the image is detected. Subsequently, posture estimation is applied to the subject in the image (to each subject if there are a plurality of subjects) to acquire posture information. Preferably, the posture information to be acquired is changed in accordance with subject type. Here, because the subjects are people, two-dimensional coordinates (x, y) of the joints 611 and joints 612 in the image are acquired. Here, the coordinates (x, y) are in the unit of pixels. A center of gravity 613 indicates the center of gravity of the ball 603, and an arrow 614 indicates the size of the ball 603 in the image. Subsequently, two-dimensional coordinates (x, y) of the center of gravity of the ball 603 in the image, and a pixel count indicating the width of the ball 603 in the image are acquired.

Note that any method may be used as the object detection method and posture estimation method, and, for example, the method disclosed in document 1 below and the method disclosed in document 2 below can be respectively applied.
(Document 1) Joseph Redmon, et al., “You only look once: Unified, real-time object detection”, Proceedings of the IEEE conference on Computer Vision and Pattern Recognition, 2016.
(Document 2) Zhe Cao, et al., “Realtime Multi-Person 2D Pose Estimation using Part Affinity Fields”, Proceedings of the IEEE Conference on Computer Vision and Pattern Recognition, 2017.

Subsequently, based on the estimated joint coordinates and at least one of the coordinates and size of the specific object, a confidence score (probability) indicating the likelihood of being the primary subject is calculated for each subject. As the probability calculation method, a method is conceivable in which a neural network, which is one type of machine learning technique, is used, with an individual neural network being prepared for each anticipated shooting scene. In the present embodiment, a case will be described in which, as a confidence score indicating the likelihood of being the primary subject (confidence score corresponding to the degree of likelihood that a subject is the primary subject in the processing-target image), the probability of the subject being the primary subject in the processing-target image is adopted. However, values other than probability may be used. For example, as the confidence score, a value such as the reciprocal of the distance between the center of gravity of a subject and the center of gravity of the specific object can be used.

Finally, the probability of one of the subjects (people) for which the above-described probability is highest is adopted as an evaluation value for the image, and this evaluation value can also be used as a visual-quality evaluation value.

In the present embodiment, description is basically provided regarding that the visual-quality evaluation value is a probability for a single subject; however, in a case as described later in which the camera system also performs the automatic selection of the image to be viewed by viewers, the visual-quality evaluation value may be calculated from the probabilities for a plurality of subjects.

Furthermore, in the present embodiment, an example is described in which probabilities for selecting the primary subject are calculated assuming a case in which a scene in which people are playing a ball game (soccer) is shot using the camera system. However, without using the positional relationship with the specific object, subject posture may be estimated (posture of an animal, vehicle, or the like may be estimated, without limitation to people) to calculate a probability, and the calculated probability may be adopted as the visual-quality evaluation value.

In the present disclosure, as long as a value for evaluating the visual quality of an image in accordance with the purpose of shooting can be calculated (or acquired), the method for calculating (or acquiring) the visual-quality evaluation value itself is not limited to the above-described method. Thus, the following examples are conceivable as other visual-quality evaluation values. In the case of sports, viewers often want to see famous players; thus, a degree of match with a subject that is pre-registered or extracted during shooting may be used as a visual-quality evaluation value. In consideration of the visibility of players, subject size, the distance of the subject from the image center, or the like may be used as an evaluation value. Furthermore, in the case of motor sports, the greater the amount of change within the screen, the more preferred the scene is as being a scene with good visual quality; thus, depending on the purpose of shooting, the amount of change in subject position within the screen, the amount of change in subject focal position within the screen, or the like can also be used as a visual-quality evaluation value. Based on such matters, it is desirable that the visual-quality evaluation value be provided to a user of the camera system in a state such that: the visual-quality evaluation value can be customized in accordance with the user's purpose of use; the method for calculating the visual-quality evaluation value is adjusted or the visual-quality evaluation value is changed for each anticipated shooting scene; or the visual-quality evaluation value is calculated by combining the above-described visual-quality evaluation value candidates.

### [Quantification of Visual Quality of Plurality of Cameras]

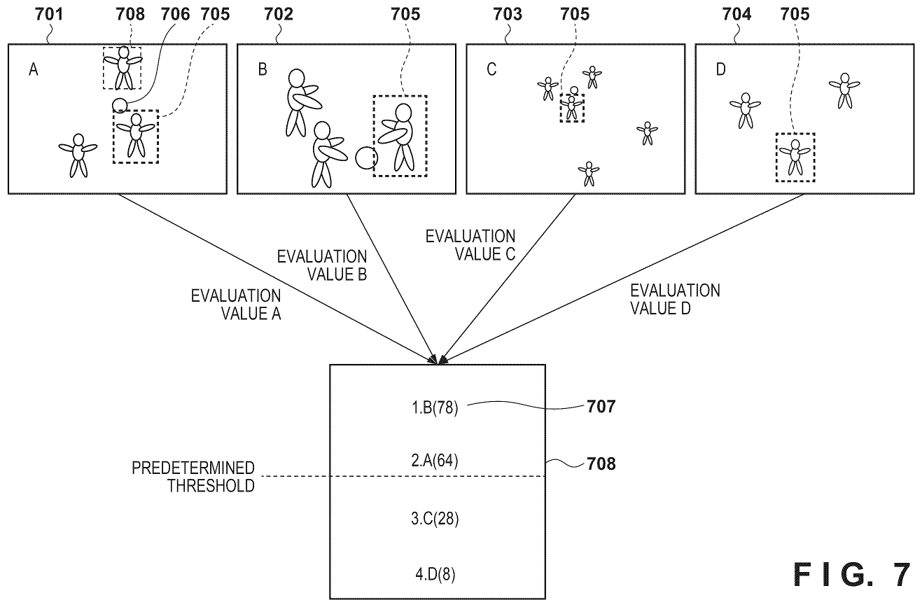

FIG. 7 is a diagram illustrating a state in which, in the camera system having the configuration in FIG. 5, visual-quality evaluation values have been calculated from individual images of a sport (ball game) shot at a certain timepoint, and the visual-quality evaluation values have been ranked. Reference symbols 701, 702, 703, and 704 respectively indicate image A shot using the first image capturing optical system 140a, image B shot using the second image capturing optical system 140b, image C shot using the third image capturing optical system 140c, and image D sot using the fourth image capturing optical system 140d. Reference symbols 705, 706, 707, and 708 respectively indicate primary subject frames, a ball, evaluation values obtained from the images, and a conceptual diagram in which evaluation values of the same subject as the primary subject 705 in the images are ranked.

A value obtained by quantifying subject posture and motion, and a value obtained by quantifying the significance of a motion in relation to a specific object can be used as values quantifying visual quality in a specific scene. Thus, in a camera system including a plurality of cameras as illustrated in FIG. 5, evaluation values (hereinafter “visual-quality evaluation values”) of subject posture and motion obtained from images shot using individual cameras are compared and ranked. Thus, the visual quality of images being shot using the individual cameras can be compared.

With reference to FIG. 7, a comparison of the visual quality of images being shot using individual cameras will be described.

First, visual-quality evaluation values of individual images shot using a plurality of cameras are calculated. Image A701 is an example in which, because a ball and people are shown in the image at appropriate sizes, the visual-quality evaluation value is high and is higher than or equal to a predetermined threshold. Image B702 is an image in which, because a ball and people are shown in the image at large sizes, the visual-quality evaluation value is higher than or equal to the predetermined threshold and is higher than that of image A701. Image C703 is an example in which, because, a ball and people are shown but at small sizes, the visual-quality evaluation value is lower than the predetermined threshold. Image D704 is an example in which, because people are shown but a ball is not, the primary subject has been selected according to a method that is not based on the visual-quality evaluation value (in the present embodiment, a subject with a high degree of match with a pre-registered image). In this case, the visual-quality evaluation value is lower than the predetermined threshold and is particularly low.

The visual-quality evaluation values of the individual images acquired in such a manner are shared within the camera network, and the images are sorted in descending order of the visual-quality evaluation values. Thus, as indicated by reference symbol 708 in FIG. 7, the images are sorted in the order of image B702, image A701, image C703, and image D704, in descending order of the visual-quality evaluation values.

Describing the case in reference symbol 708 in FIG. 7 in further detail, image B702 can be extracted as the image with the best visual quality if the image with the best visual quality is to be extracted in the simplest manner. The method of ranking visual-quality evaluation values and extracting the image with the highest evaluation value is advantageous in that a simple camera system configuration can be obtained. On the other hand, it is not necessarily the case that the image with the highest visual-quality evaluation value is always an image with good visual quality for humans. For example, in a case in which no image with good visual quality is being shot by any of the cameras being used to shoot images, an image desired by viewers would not be obtained by simply extracting the image with the highest visual-quality evaluation value.

As a method that would allow a live streaming provider to more accurately select an image with good visual quality in a case in which no image with good visual quality is being shot by any of the cameras being used to shoot images, it would be conceivable to set a threshold for visual-quality evaluation values. Then, if there is no image with a visual-quality evaluation value higher than or equal to the predetermined threshold, a notification to that effect is provided to the live streaming provider via display, sound, etc. In this case, unless a notification indicating that there is no image with a visual-quality evaluation value higher than or equal to the predetermined threshold is provided, it is sufficient that the live streaming provider judge that one or more scenes with good visual quality have been selected by the camera system and check the images. If a notification indicating that there is no image with a visual-quality evaluation value higher than or equal to the predetermined threshold is provided, an image with a high visual-quality evaluation value may be provisionally provided to viewers, or another measure, such as streaming an image that is intended for viewers to view, may be taken.

[Methods for Presenting and Automatically Selecting Image with High Visual-Quality Evaluation Value]

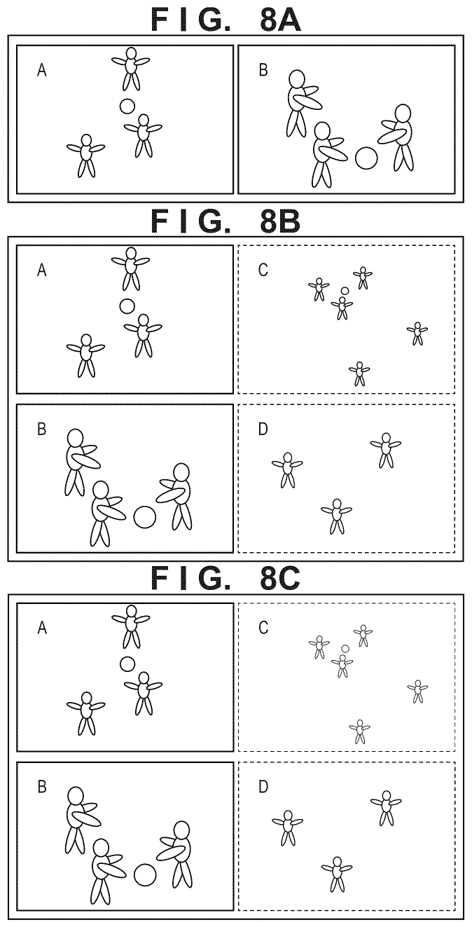

FIGS. 8A to 8C are diagrams describing methods for presenting, to a camera-system user such as a live streaming provider, images with high visual-quality evaluation values described with reference to FIG. 7.

First, a case will be described in which the camera system uses the visual-quality evaluation value, etc., to extract images with good visual quality from among images being shot and presents the extracted images to the user, and the user selects an image to be shown to viewers from among the extracted images, whereby an image to be streamed is finally determined.

In a case in which only images with high visual-quality evaluation values are to be presented to the user, a method (display control method) is conceivable in which only images (images A701 and B702 in FIG. 7) with visual-quality evaluation values exceeding a predetermined threshold are displayed, as illustrated in FIG. 8. One advantage of this method is that, because the number of displayed images is limited, the number of images to be checked by the user decreases. On the other hand, one disadvantage of this method is that, if a subject having a factor that cannot be reflected by the visual-quality evaluation value is shown in one or more images, images having good potential as a streaming image would be overlooked. For example, a subject having a factor that cannot be reflected by the visual-quality evaluation value is: a pre-registered person; in the case of sports, etc., a characteristic behavior of spectators during a game; in the case of nature observation, etc., a rare animal that is not supported by the subject recognition function of the cameras; or the like.

In a case in which the method in FIG. 8A is used, it is preferable that, so that the user can check the images more easily, a method be adopted such as ranking and displaying images in the order of visual-quality evaluation values or displaying the ranks when the images are ranked by visual-quality evaluation values above the images. Furthermore, a method such as performing thumbnail display to create a contrast between the images is also conceivable.

As a method for overcoming the disadvantage of FIG. 8A, a method such as that described in the following is conceivable. Specifically, as illustrated in FIG. 8B, while also displaying images (images C703 and D704 in FIG. 7) with visual-quality evaluation values lower than the predetermined threshold, the images (images A701 and B702 in FIG. 7) with visual-quality evaluation values higher than or equal to the predetermined threshold are displayed in highlighted state so as to be distinguishable. Additionally displaying images with visual-quality evaluation values lower than the predetermined threshold would make it difficult to instantly find the images with high visual-quality evaluation values due to an increase in the amount of information on the displayed screen, even if the ranks of the visual-quality evaluation values are clearly displayed. Thus, by taking a measure such as varying the display-image highlighting method in accordance with the ranks of visual-quality evaluation values, images with high visual-quality evaluation values can be displayed so as to be more easily recognizable by the user.

Furthermore, as another example, a method is conceivable of extracting and displaying candidate images based on a combination of factors by also using an evaluation value (in the present embodiment, the degree of match with a pre-registered image, which was used to detect the primary subject in image D704) other than the visual-quality evaluation value. In this case, a method is conceivable of presenting an image extracted using an evaluation value other than the visual-quality evaluation value, such as image D704 in FIG. 8C, using a display method differing from that of the images with high visual-quality evaluation values.

In the present embodiment, description is provided assuming ball games as sports; given this, a banner and a uniform worn by a cheering team (cheerleaders, etc.) may be registered in advance as images, for example. Furthermore, a camera for shooting an image of the spectator seats is prepared. This makes it possible to quickly notify the user if the banner is raised and cheering is started or cheering by the cheering team is started. That is, the user can be informed of information from various angles. In doing so, there are cases in which the uniform display of all images may reduce visibility due to an excess in information. In such cases, the display method is varied such that, as in FIG. 8C, the image D704, of which the visual-quality evaluation value and the degree of match with a registered image both fall below the predetermined thresholds, is displayed faintly to limit the visibility thereof.

In the present embodiment, methods as illustrated in FIGS. 8A to 8C are described as image presentation methods for comparing visual quality. However, the display methods have advantages and disadvantages; given this, the camera system can be made versatile by configuring the camera system so as to be capable of combining and switching between the display methods.

This concludes the description of methods for presenting, to the user, images being shot using a plurality of cameras so that the visual quality of the images can be compared. In this case, it is up to the user to select an image to be streamed to viewers from images whose degrees of visual quality are presented.

On the other hand, in the following, description will be provided of a case in which the camera system automatically selects (edits) an image to be streamed to viewers, as processing for further developing the above-described methods.

As one automatic selection method, the camera system is caused to select the image with the highest visual-quality evaluation value, whereby the image to be shown to viewers can be automatically selected (edited). In doing so, in order to allow the camera system to automatically select an image to be streamed to viewers in a state in which user intention is further reflected, it is conceivable to adjust the visual-quality evaluation value by incorporating other factors. Furthermore, it is also conceivable to adjust the visual-quality evaluation value so that, if there is an image satisfying a predetermined condition, the image is exceptionally ranked highest in the ranking of visual-quality evaluation values, etc.

First, as a method for calculating the visual-quality evaluation value by incorporating other factors, a method is conceivable of adjusting a parameter for calculating the visual-quality evaluation value in accordance with subject size, the number of subjects, the scene of use, etc.

A method as described in the following is conceivable as a method for adjusting the visual-quality evaluation value by taking subject size into consideration. A method in which human posture is estimated by preparing training data corresponding to different subject sizes is known as a publicly known technique. By applying this method, the weight applied to evaluation values in individual postures is varied based on subject sizes. This makes it possible to adjust, based on subject sizes, values of the visual-quality evaluation value in accordance with a characteristic posture, the positional relationship between the characteristic posture and the specific object, or the like. If values of the visual-quality evaluation value can be adjusted based on subject sizes, the visual-quality evaluation value can be adjusted based on subject size during the shooting of sport images. In the case of a ball game in which there are goals, such as soccer and basketball, it also becomes possible for the camera system to automatically select an image in which a subject taking a shot, a ball, and a goal are shown together in a shot image over an image in which the subject taking a shot and the ball are shown at large sizes, etc.

In order to adjust values of the visual-quality evaluation value by taking the number of subjects into consideration, a method is conceivable of calculating visual-quality evaluation values for all candidate subjects extracted from an image, and varying the method according to which the visual-quality evaluation value of each subject is added in accordance with the number of subjects. In doing so, it is preferable to limit the number of people of which the visual-quality evaluation values are to be added. For example, the visual-quality evaluation value of an entire image is calculated such that: the visual-quality evaluation values of subjects having the top three visual-quality evaluation values, among a plurality of subjects shown in the image, are simply added; and the weighting coefficient for the nth visual-quality evaluation value is ½ⁿ⁻¹, for example. The formula for calculating the visual-quality evaluation value E of the entire image can be represented by formula (1), for example, where en is the nth visual-quality evaluation value, dn is the weighting coefficient for the nth visual-quality evaluation value, and E is the visual-quality evaluation value of the entire image.

$$E = e 1 \times d 1 + e 2 \times d 2 + e 3 \times d 3 = e 1 + e 2 / 2 + e 3 / 4 \qquad ( 1 )$$

Formula (1) describes a case in which the number of subjects is three. However, user intention can be reflected with higher versatility by adopting a configuration such that the number of subjects and visual-quality-evaluation-value weighting coefficient dn are adjustable in accordance with the scene and purpose of shooting of the camera system and are prepared in plurality in the camera system side in advance.

In order to adjust the visual-quality evaluation value by taking the scene-of-use condition into consideration, templates of visual-quality-evaluation-value calculation methods are prepared in advance in the camera system side presuming a plurality of scenes of use. Then, a template for calculating the visual-quality evaluation value is selected by having the user select the scene of use of the camera system. Alternatively, by performing subject posture detection and object detection in one or more images being shot, the camera system automatically determines the scene of use and selects a template for calculating the visual-quality evaluation value. Furthermore, if user intention is to be reflected to a further extent, a configuration is adopted such that the visual-quality-evaluation-value calculation method of the camera system can be customized. For example, a configuration is adopted such that, in the above-described method of providing weights based on differences in subject size and the method of calculating the visual-quality evaluation value in accordance with the number of subjects, the user can customize the number of subjects and the method according to which the weighting coefficients are set.

This concludes the description of examples in which the visual-quality evaluation value is adjusted by incorporating other factors.

Subsequently, description will be provided of an example of the method in which, if there is an image satisfying a predetermined condition, the image is exceptionally ranked highest in the ranking of visual-quality evaluation values. As an example of this method, a method can be mentioned in which, if an image that is similar to an image registered in advance in the camera system is shot, the degree of match between the image and the registered image is calculated on the same axis as the visual-quality evaluation value or as a second axis. For example, there are cases in which, during live image streaming, an image that is shot for a purpose different from the main purpose of shooting is inserted in order to prevent the viewers viewing the live image being streamed from feeling bored. In such a case, a configuration is adopted such that: a second visual-quality evaluation value that is calculated according to a method that is different from that for the main visual-quality evaluation value is set; and, if specific conditions are fulfilled (in the present embodiment, if a subject having a high degree of match with a registered image is detected), the second visual-quality evaluation value is ranked highest among visual-quality evaluation values. This makes it possible to exceptionally set an image satisfying a predetermined condition highest in the ranking of visual-quality evaluation values.

This concludes the description of methods for allowing the camera system to automatically select an image to be streamed to viewers.

[Flowchart for Presenting and Automatically Selecting Image with High Visual-Quality Evaluation Value]

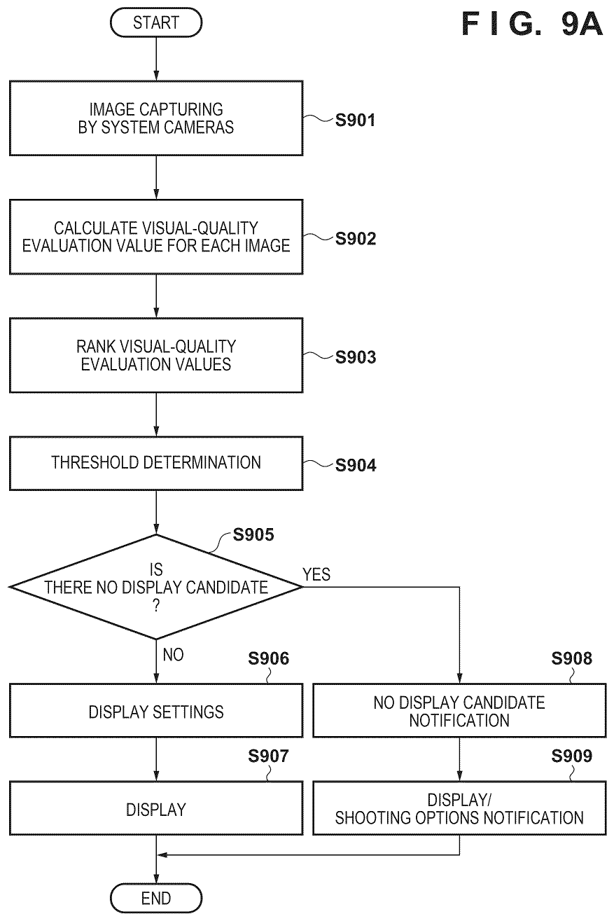

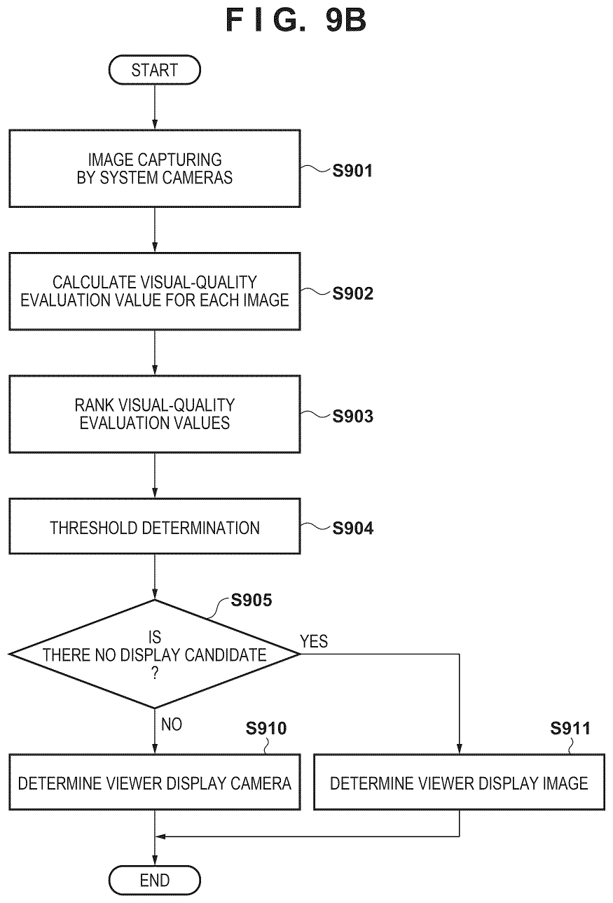

FIG. 9A is a flowchart illustrating an operation in the present embodiment in which the camera system presents images with high visual-quality evaluation values to the user. The operation in this flowchart is realized by the CPU 121 reading out and executing a predetermined program stored in the internal ROM or RAM. Note that the operations in the other flowcharts to be described in the following are also realized by the CPU 121 executing the predetermined program.

In step S901, the CPU 121 acquires images using the plurality of cameras included in the camera system (in the present embodiment, the first image capturing optical system 140a, the second image capturing optical system 140b, the third image capturing optical system 140c, and the fourth image capturing optical system 140d). The cameras (first to fourth image capturing optical systems 140a to 140d) in the camera system may be connected by a wired connection method or a wireless connection method. As long as images and image-related information can be shared within the camera system, any such cameras can be treated as being cameras in the camera system.

In step S902, the CPU 121 uses the evaluation value processing means 121e and calculates, from each image acquired in step S901, a visual-quality evaluation value corresponding to the image. In the present embodiment, description will be provided with reference to an example in which, as description has been provided with reference to FIG. 8C, a visual-quality evaluation value based on subject posture estimation and a visual-quality evaluation value based on a value (subject matching degree) of the degree of match with an image registered in the camera system in advance are calculated as independent evaluation values. However, for convenience of description, a “visual-quality evaluation value” refers to a value based on subject posture estimation, and a visual-quality evaluation value based on a subject matching degree is referred to as a “subject matching degree” in the following description.

Note that, as methods for automatically selecting an image to be streamed to viewers in a state in which user intention is reflected, methods in which an evaluation value calculation parameter is adjusted based on subject size, the number of subjects, and the scene of use when the visual-quality evaluation value is calculated have been described above. Such methods may be used in step S902.

In step S903, the CPU 121 ranks the visual-quality evaluation values calculated in step S902. In the present embodiment, visual-quality evaluation values and subject matching degrees are separately ranked.

In step S904, the CPU 121 determines whether or not each piece of data in the ranking of each of the visual-quality evaluation values and subject matching degrees ranked in step S903 is higher than or equal to the corresponding predetermined threshold.

In step S905, the CPU 121 advances processing to step S908 determining that there is no display candidate if there is no image with a value higher than or equal to the predetermined threshold as a result of the determination in step S904, and otherwise advances processing to step S906. In the present embodiment, the CPU 121 regards that there is a display candidate and advances processing to step S906 if there is an image with a subject matching degree higher than or equal to the predetermined threshold, even if there is no image with a visual-quality evaluation value higher than or equal to the predetermined threshold.

In step S906, based on the results of the processing in steps S903 and S904, the CPU 121 establishes display settings of a presentation to the user corresponding to the ranking of visual-quality evaluation values. In the present embodiment, settings are established such that, as described with reference with FIG. 8C, ranking results of display images can be distinguished by varying numerals indicating ranks and the display of image frames. Furthermore, in the present embodiment, the display of frames for informing the user of the primary subject that is in focus is also set here. In regard to the display of frames for informing the user of the primary subject, the needs of a wider range of users can be addressed by adopting a configuration such that the display of frames can also be switched off in accordance with user settings.

As a specific example of the settings of the presentation to the user, for image A701 for example, because the visual-quality evaluation value of image A701 is ranked second as illustrated in FIG. 7, a setting is established such that “2” is displayed as the display of rank and display in highlighted state is performed using the second thickest frame of solid lines.

For image B702, because the visual-quality evaluation value of image B702 is ranked first, a setting is established such that “1” is displayed as the display of rank and display in highlighted state is performed using the thickest frame of solid lines.

For image C703, because the visual-quality evaluation value of image C703 is lower than the predetermined threshold although being ranked third, a setting is established such that “3” is displayed as the display of rank and the entire image is displayed in a non-highlighted state. In the present embodiment, while an image with a visual-quality evaluation value lower than the predetermined threshold is displayed in a non-highlighted state by being made transparent, such an image may be completely hidden.

For image D704, while the visual-quality evaluation value of image D704 is ranked fourth and is also lower than the predetermined threshold, a subject with a high degree of match with a registered image is present in the image. Thus, a setting is established such that “4” is displayed as the display of rank and display in highlighted state is performed using a thick frame of dash-dot lines, which is a highlighted display set in advance for a case in which the subject matching degree is high.

In step S907, based on the display settings established in step S906, the CPU 121 displays on the display unit 131 and presents to the user images shot by the camera system and ranking results of visual-quality evaluation values.

In step S908, the CPU 121 displays, on the display unit 131, predetermined display prepared by the camera system for a case in which there is no display candidate image. Here, in a case in which the visibility on the display unit 131 would decrease by displaying a message indicating that there is no display candidate image on the display unit 131, presentation to the user may be performed according to a method that does not rely on display, such as presentation via sound.

In step S909, the CPU 121 displays, via the display unit 131, options prepared by the camera system for preparing alternative display candidates for when there is no display candidate image. Alternatively, the CPU 121 performs presentation via sound.

Option candidates include a moving image prepared in advance (introduction of team members, advertisement, or pre-registered video), a still image prepared in advance (introduction of sponsor, etc.), a later-described automatic shooting option of the camera system, etc. By proposing to the user an image to be displayed until an image with good visual quality emerges in a case in which there is no image with good visual quality, the user work load for selecting a viewer display image can be reduced.

In the present embodiment, the flowchart in FIG. 9A is used to describe a case in which display as illustrated in FIG. 8C is performed; however, display as illustrated in FIG. 8A or FIG. 8B can also be performed.

If display as illustrated in FIG. 8A is to be performed, it is sufficient that settings be established in step S906 such that all images with visual-quality evaluation values not exceeding the predetermined threshold are hidden. Depending on user needs, settings may be established here for rearranging display images into a predetermined order (in the case illustrated FIG. 8A, images are arranged in descending order of visual-quality evaluation values from the left).

If display as illustrated in FIG. 8B is to be performed, it is sufficient that settings be established in step S906 such as displaying an image frame using dotted lines for images with visual-quality evaluation values not exceeding the predetermined threshold so that such images are visually distinguishable.

This concludes the description of the operation for presenting images with high visual-quality evaluation values to the user.

Subsequently, with reference to the flowchart in FIG. 9B, an operation in which the camera system automatically selects an image to be streamed to viewers will be described.

Steps S901 to S905 are similar to those in the case illustrated in FIG. 9A, and description thereof is thus omitted.

In step S910, based on the data obtained by separately ranking the visual-quality evaluation values and the subject matching degrees in step S903, the CPU 121 selects the final image to be streamed to viewers. The camera system automatically selects the image to be streamed to viewers according to a method as described in the [Methods for Presenting and Automatically Selecting Image with High Visual-Quality Evaluation Value] section.

In step S911, based on preset user configurations, a pre-registered image or an image automatically shot based on a predetermined program by cameras in the camera system is displayed. The automatic shooting will be described in detail in the second embodiment.

As described above, in the present embodiment, visual-quality evaluation values of images shot by the plurality of cameras in the camera system are calculated, and the calculated visual-quality evaluation values are ranked. Thus, in accordance with each shooting scene, the live streaming image provider (user) can easily select one or more candidate images with good visual quality from the plurality of camera images. This also makes it possible for the camera system to automatically select an image to be streamed to viewers.

This concludes the description of the streaming image selection operation in the present embodiment. In the flowchart in FIG. 9A, the processing in step S907 has been described individually for cases in which display methods as illustrated in FIGS. 8A to 8C are adopted; however, the methods illustrated in FIGS. 8A to 8C may be combined.

Furthermore, in the present embodiment, description is provided on the assumption that probabilities based on subject posture estimation are the primary visual-quality evaluation values, and the subject matching degrees are secondary visual-quality evaluation values. However, depending on the shooting scene, evaluation values based on another criterion may be used as primary visual-quality evaluation values.

Furthermore, while two types of visual-quality evaluation values are separately described in the present embodiment, a configuration may be adopted such that the camera system is controlled by combining a plurality of visual-quality evaluation values to calculate a single visual-quality evaluation value.

By evaluating and comparing the visual quality of images shot by the plurality of cameras in the camera system in such a manner, one or more images with a high visual-quality evaluation value can be presented to the user and an image to be streamed to viewers can be automatically selected.

### Second Embodiment

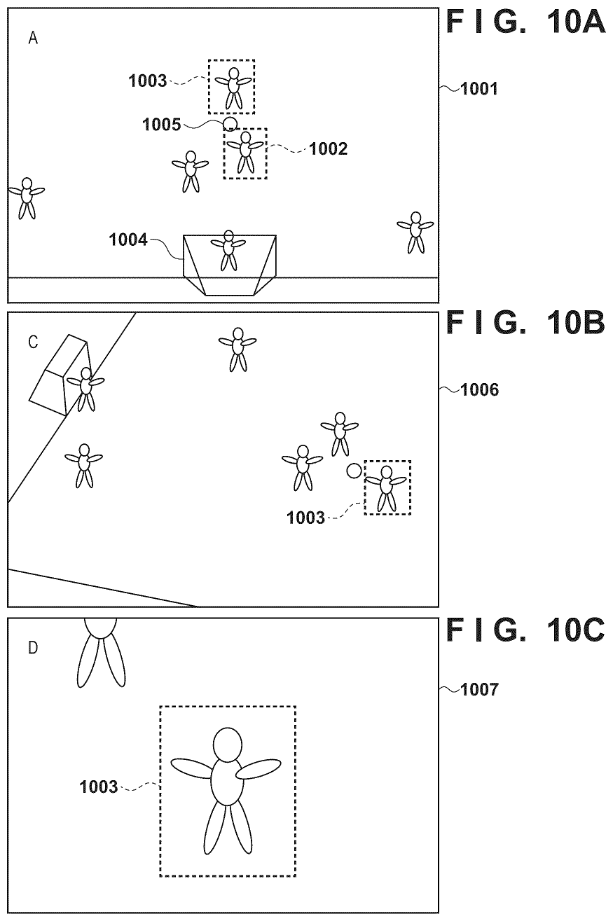

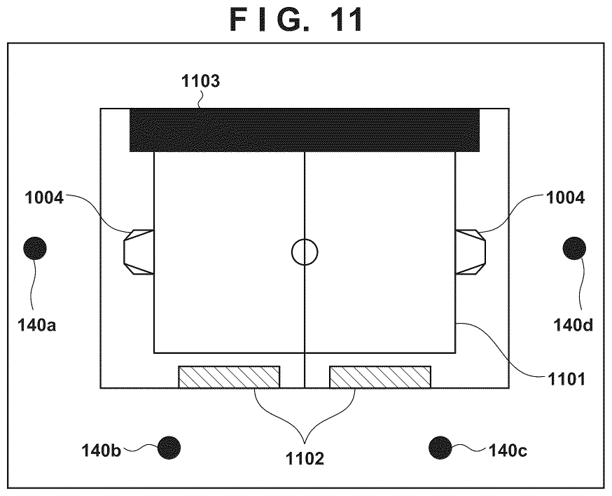

Next, a second embodiment of the present disclosure will be described. In the present embodiment, with reference to FIGS. 10A to 10C, and FIG. 11, a case will be described in which visual-quality evaluation values are used to perform automatic shooting using the cameras in the camera system. Note that the camera system configuration is the same as that in the first embodiment, and description thereof is thus omitted.

### [Automatic Shooting Using Data of Ranks of Visual-Quality Evaluation Values]

FIGS. 10A to 10C each illustrate a state in which the composition has been changed from a composition in FIG. 7 by automatic shooting. Reference symbol 1001 indicates an image obtained by changing the angle of view to the wide-angle side from the composition of image A701. Reference symbols 1002, 1003, 1004, and 1005 respectively indicate the primary subject in image A1001, a subject determined as the primary subject in image B702, a soccer goal, and a ball. Reference symbol 1006 indicates an image obtained by changing the shooting direction toward the left from the composition of image B702. Reference symbol 1007 indicates an image obtained by changing the angle of view to the telephoto side from the composition of image D704 and then changing the shooting direction so that the primary subject is positioned at the image center.

FIG. 11 is a diagram illustrating an example in which the cameras (first to fourth image capturing optical systems 140a to 140d) in the camera system according to the present embodiment have been laid out assuming automatic shooting of soccer. Reference symbols 1101, 1102, and 1103 respectively indicate an area (stadium) in which players will play a game, players' benches, which are an automatic shooting option candidate, and the spectator seats, which are an automatic shooting option candidate. For convenience of description, description will be provided in the following referring to the first image capturing optical system 140a, the second image capturing optical system 140b, the third image capturing optical system 140c, and the fourth image capturing optical system 140d as camera 1, camera 2, camera 3, and camera 4, respectively.

Camera 1 is disposed behind a left-side soccer goal 1004, and is in a position from which an image including the front sides of players attacking toward the left half of the stadium 1101, and the left halves of the spectator seats 1103 and the stadium 1101 can easily be shot. Camera 2 is in a position from which an image including the overall view of the left halves of the spectator seats 1103 and the stadium 1101 can easily be shot. Camera 3 is in a position from which an image including the overall view of the right halves of the spectator seats 1103 and the stadium 1101 can easily be shot. Camera 4 is disposed behind a right-side soccer goal 1004, and is in a position from which an image including the front sides of players attacking toward the right half of the stadium 1101, and the right halves of the spectator seats 1103 and the stadium 1101 can easily be shot. By setting the role of each camera in advance, different compositions can be provided to the user.

In order to use visual-quality evaluation values and perform automatic shooting using the cameras in the camera system, a method in which the camera system performs shooting taking composition into consideration, and a method in which shooting is performed mechanically in accordance with a predetermined sequence are conceivable.

[Automatic Shooting in which Camera System Increases Visual-Quality Evaluation Value Taking Composition into Consideration]

First of all, a method will be described in which the camera system performs shooting taking composition into consideration. In live streaming, it is not required that compositions similar to that of the image with the highest visual-quality evaluation value be shot using a plurality of cameras; thus, control is performed so that the composition being currently shot is changed and then the visual-quality evaluation value of the shot image is increased.

As illustrated in FIG. 11, the cameras in the camera system are typically laid out surrounding the stadium 1101. With this camera layout, a soccer goal 1004 would be included in the screen if wide-angle shooting is performed, and one or more players would be shot in close-up when telephoto shooting is performed. In such a manner, by adjusting the angle of view between telephoto and wide-angle, the composition of a shot image can be mechanically defined.

In ball games, a scene in which a player takes a shot and the shot ball enters a goal is preferred by users as a scene with particularly good visual quality. Thus, preemptively shooting both a zoomed-in image of a subject close to the ball and an image including the ball, one or more subjects, and a goal has the effect of increasing options from which the user can select an image to be streamed to viewers. Thus, this approach is effective as control of automatic shooting by the camera system.

In such a manner, by taking into consideration the fact that telephoto shooting produces a close-up image of one or more subjects and wide-angle shooting produces an image including a goal and one or more subjects, automatic shooting of an effective composition becomes possible. A specific example will be described in the following.

Suppose that, in FIG. 7, image B702 has been selected as the image to be streamed to viewers because image B702 has a high visual-quality evaluation value. Image B702 is an image shot using camera 2. Because a zoomed-in image of subjects is already being shot in image B702, it is desired that an image including both a goal and one or more subjects be further shot. From the positional relationship between the primary subject 705 and the ball 706 in image B702, it can be predicted that the primary subject 705 will move toward the left in the stadium 1101 in FIG. 11. Thus, it can be determined that the camera that is suitable for shooting an image of both a goal and one or more subjects is camera 1.

After camera 1 (140a) is selected as the camera to be used for automatic shooting, control for varying the angle of view from that of camera 2 (140b) is automatically performed. Specifically, in the present embodiment, because the camera 2 is performing shooting of subjects on the telephoto side, the camera 1 is switched to wide-angle shooting. Thus, both a zoomed-in image (image B702) and image A1001, which is obtained by changing the composition to the wide-angle side from image A701, can be obtained, and thus an image with good visual quality can be automatically shot.

The camera system can mechanically control the switching between telephoto shooting and wide-angle shooting by detecting shooting-lens focal length. The adjustment of angle of view can be precisely controlled by determining subject size on the telephoto side and determining the presence/absence of a soccer goal 1004 on the wide-angle side. The presence/absence of a soccer goal 1004 can be determined according to a method such as that of registering an image of the goal in advance and determining the degree of match between a subject and the registered image, or that of preparing image training data and performing subject recognition on the soccer goal 1004. In regard to the adjustment of the angle of view on the wide-angle side, the accuracy of automatic control of the adjustment of the angle of view can be improved by performing subject detection and detecting not only the presence/absence of a soccer goal 1004 but also the size thereof. In doing so, it is effective to share primary subject information of camera 2 and primary subject information of camera 1 between the two cameras, in addition to performing the adjustment of the angle of view. For example, if the primary subject of camera 1 (140a) and the primary subject of camera 2 (140b) are different, control is performed so that both primary subjects are in focus. This makes it possible to use camera 1 and shoot an image with a high visual-quality evaluation value having a composition different from that of camera 2.

More specifically, the focal positions of the primary subject 1002 and the primary subject 1003 (primary subject 709 in image A701) in image A1001 are calculated, and the focus is set to an intermediate position between the focal positions. Furthermore, the aperture value required to place the primary subjects 1002 and 1003 both in focus is calculated by a conventional depth-of-field calculation formula based on the difference between the focal positions of the primary subjects 1002 and 1003. Then, the diaphragm is adjusted to the calculated aperture value. This makes it possible to shoot an image in which both the primary subjects 1002 and 1003 are in focus.

When shooting an image in which both the primary subjects 1002 and 1003 are in focus, an image with an even higher visual-quality evaluation value can be shot by performing exposure control adapted to both the primary subjects 1002 and 1003.

In the description above, description has been provided of a case in which camera 1 is selected as the camera to be used for automatic shooting by determining a subject movement direction from the positional relationship between the primary subject 705 and the ball 706 in image B702. However, a method is also conceivable of ranking visual-quality evaluation values, selecting a camera to be used for automatic shooting from among one or more cameras with visual-quality evaluation values not exceeding the predetermined threshold, and performing shooting in a state in which composition is changed so that an image with good visual quality can be shot.

As a case in which one camera to be used for automatic shooting is selected from among one or cameras with visual-quality evaluation values not exceeding the predetermined threshold, it is conceivable in the present embodiment to select camera 3 as the camera closest to camera 2 currently shooting the image to be streamed to viewers. If camera 3 is selected as the automatic shooting camera, it is determined based on the positional relationship between the primary subject 705 and the ball 706 in image C703 whether the soccer goal 1004 to be detected is that on the right side or the left side, in order to shoot an image including a goal and the primary subject. In the present embodiment, it is determined that the soccer goal 1004 is on the left side; thus, the angle of view is changed to the wide-angle side until the left-side soccer goal 1004 is detected. Subsequently, based on the positional relationship between the primary subject 705 and the soccer goal 1004, the shooting direction of the camera 3 is automatically adjusted so that both the primary subject 705 and the soccer goal 1004 can be shot with good balance. Once the shooting direction has been adjusted, the angle of view is adjusted so that the primary subject 705 and the soccer goal 1004 are in appropriate sizes. Thus, the composition of image C703 is changed to the composition of image C1006 in FIG. 10B, which is an image with a high visual-quality evaluation value. The primary subject 705 in image C703 and the primary subject in image C1006 are the same subject.

Furthermore, while a case in which one camera to be used for automatic shooting is selected has been described in the description above, a plurality of cameras may be automatically selected. A plurality of cameras adjacent to the camera being used to shoot the image to be streamed to viewers, or, in a case such as in the present embodiment in which there are not many cameras, all other cameras may be selected.

Basically, the adjustment of angle of view results in a significant change in an image; thus, it is desirable that a significant change in angle of view be performed using a camera other than the camera being used to shoot the image to be streamed to viewers. However, a change in angle of view for preventing a change in the size of one or more subjects in an image would be preferable for viewers. Thus, it is rather desirable that, in the camera being used to shoot the image being streamed to viewers, the angle of view be adjusted in order to prevent a fluctuation in the size of the primary subject.

Up to this point, as the method in which the camera system performs automatic shooting taking composition into consideration, a method in which the angle of view is changed has been mainly described. However, as a method for changing the shooting composition, a change in shooting direction may be performed. As a method for automatically controlling the shooting direction, a method is conceivable of automatically tracking the primary subject in an image being shot by detecting the movement direction of the subject. Furthermore, in a case in which there are a plurality of subjects in an image, it is conceivable to perform control so that the center position of the plurality of subjects is positioned at the center of the angle of view.

In a case in which a subject is automatically tracked, subject size is optimized by adjusting the shooting angle of view based on the subject matching degree with a pre-registered image, which is one type of visual-quality evaluation value, as illustrated in image D1007 in FIG. 10C. Then, automatic shooting is performed so that the visual-quality evaluation value increases by adjusting the shooting direction and optimizing the position in the image. By preemptively preparing such a control method as a configuration of the camera system, the user would be able to acquire a candidate image of the image to be streamed to the viewer at all times, and an automatic shooting mode that is advantageous for the user would be obtained.

This concludes the description of the method in which the camera system performs automatic shooting taking composition into consideration. Subsequently, a method will be described in which automatic shooting is performed mechanically in accordance with a predetermined sequence.

[Automatic Shooting in Accordance with Predetermined Sequence]

It is commonplace to, as an image for filling the time gap in a case in which no scene with good visual quality is being shot by any camera (during the break between the first and second halves of a game, during the waiting time before a game, etc.), live stream the state of the spectators and the benches to viewers in a predetermined sequence. Preparing an automatic shooting sequence similar to this in correspondence with the purpose of use of the camera system would result in a function preferable for the user.

A specific case in which automatic shooting is performed according to a predetermined sequence will be described with reference to FIG. 11.

Suppose that, at a given timepoint, all images in the camera system have visual-quality evaluation values lower than the predetermined threshold. For such a case, the user selects in advance, as an automatic shooting mode, a mode for automatically shooting the spectator's seats and benches according to a predetermined sequence. If this mode is set, the camera system first uses camera 2 (140b) to automatically shoot the spectator seats 1103 from the left side to the center thereof while changing the shooting direction. Subsequently, the camera system uses camera 3 (140c) to automatically shoot the spectator seats 1103 from the center to the right side thereof. Subsequently, the camera system uses camera 1 (140a) to automatically shoot a zoomed-in image of the players in the left-side bench 1102 while gradually narrowing the angle of view. Once the players have been zoomed-in to some extent, the camera system uses camera 4 (140d) to automatically shoot a zoomed-in image of the players in the right-side bench 1102 while gradually narrowing the angle of view. Finally, the camera 2 (140b) automatically shoots a wide-angle image such that the entirety of the spectator seats 1103 and the stadium 1101 is included in the angle of view. Such a sequence is registered in advance as an automatic shooting sequence. Here, for example, a configuration is adopted such that, if a subject having a high degree of match with a pre-registered image is detected in an image being shot, switching is performed so that the detected subject is automatically shot, even if automatic shooting based on the predetermined sequence is being performed. By incorporating such a configuration to the camera system, a camera system that is capable of performing automatic shooting with a stronger live feel is realized.

### [Flowchart for Automatic Shooting Using Visual-Quality Evaluation Values]

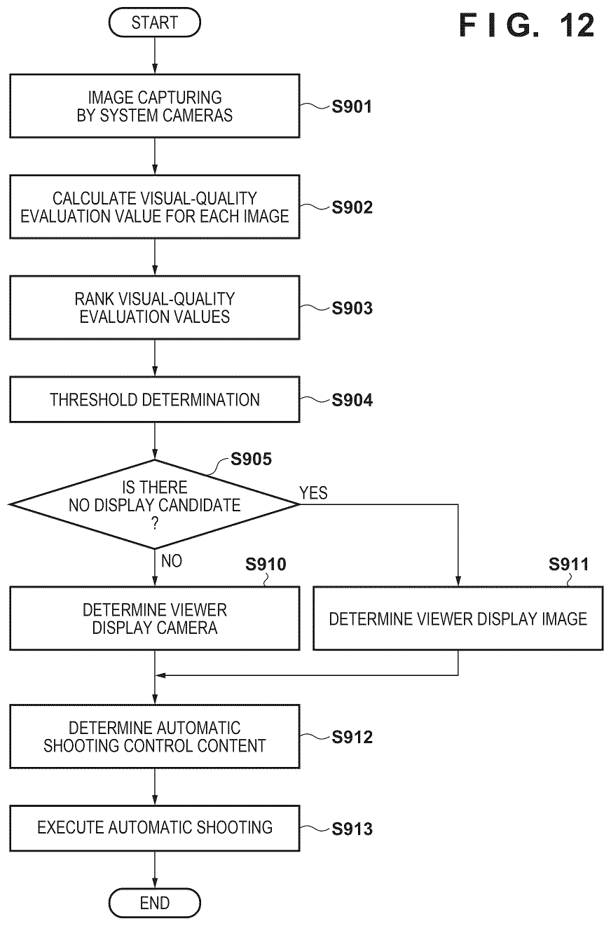

FIG. 12 is a flowchart illustrating an automatic shooting operation in the present embodiment in which data obtained by ranking visual-quality evaluation values is used. In the present embodiment, a case in which images shot by the camera system are as illustrated in FIG. 7 will be described.

The operations in steps S901 to S905, step S910, and step S911 are similar to those in FIG. 9B, and description thereof is thus omitted.

In step S912, the CPU 121 determines automatic shooting control to be performed so as to be varied between a case in which the previous step is step S910 and a case in which the previous step is step S911.

First, description will be provided of a case in which processing advances to step S912 from step S910. In this case, the camera to be used for streaming to viewers (hereinafter “viewer streaming camera”) has been determined, and thus the CPU 121 sets the camera to a subject-tracking automatic shooting mode. This is because, in addition to the visual-quality evaluation value of the composition of the image being currently shot being high, it is preferred that an image not involving a significant fluctuation in angle of view be streamed to viewers. In order to realize shooting in which the fluctuation in angle of view is suppressed, it is required that the shooting direction be adjusted so that the position of the primary subject in the image does not significantly change and that the angle of view be adjusted so that subject size does not significantly change. Thus, subject-tracking shooting is appropriate. In the present embodiment, camera 2 (140b) is set to the automatic-tracking shooting mode.

In regard to the setting of automatic shooting by cameras other than the viewer streaming camera, in the present embodiment, automatic shooting control is performed with respect to cameras adjacent to the viewer streaming camera (camera 1 (140a) and camera 3 (140c)). The cameras adjacent to the viewer streaming camera are subjected to automatic shooting control for reasons as described below. First of all, in consideration of the camera layout in the present embodiment illustrated in FIG. 11, the camera system would be able to easily control a plurality of cameras if the cameras are those adjacent to the viewer streaming camera. Furthermore, because such cameras are located at a close distance from the viewer streaming camera, such cameras are readily adaptable to both telephoto shooting and wide-angle shooting. In the present embodiment, camera 2 (140b), which is the viewer streaming camera, usually performs telephoto shooting. Thus, when the CPU 121 checks the focal length of the lens of camera 2, it is usually detected that camera 2 is set to the telephoto side. Based on such information, the CPU 121 determines to cause camera 1 (140a) and camera 3 (140c) to execute automatic shooting with a wide angle of view. The method for controlling each of the shooting-direction adjustment, the angle-of-view adjustment, the focal-position adjustment, the aperture-value adjustment, and the exposure adjustment during wide-angle shooting may be any of the methods described in the [Automatic Shooting in which Camera System Increases Visual-Quality Evaluation Value Taking Composition into Consideration] section.

Subsequently, description will be provided of a case in which processing advances to step S912 from step S911.

The CPU 121 reads the automatic shooting settings set in advance in the camera system in step S911, and causes cameras to execute automatic shooting based on the settings. The specific control method may be the method disclosed in the [Automatic Shooting in Accordance with Predetermined Sequence] section, or a shooting method that has been customized and registered in advance by the user may be executed.

As described above, according to the present embodiment, automatic shooting using cameras in the camera system can be performed by calculating visual-quality evaluation values of images shot by the plurality of cameras in the camera system and ranking the calculated visual-quality evaluation values.

### Third Embodiment

Next, a third embodiment of the present disclosure will be described. In the present embodiment, a method will be described in which visual-quality evaluation values are used to automatically delete images shot in the camera system and to record images shot in the camera system in a state in which sections are automatically set. Furthermore, a method will be described in which highlight scenes are automatically edited by recording visual-quality evaluation values in association with recorded images. Note that the camera system configuration is similar to that in the first embodiment, and description thereof is thus omitted.

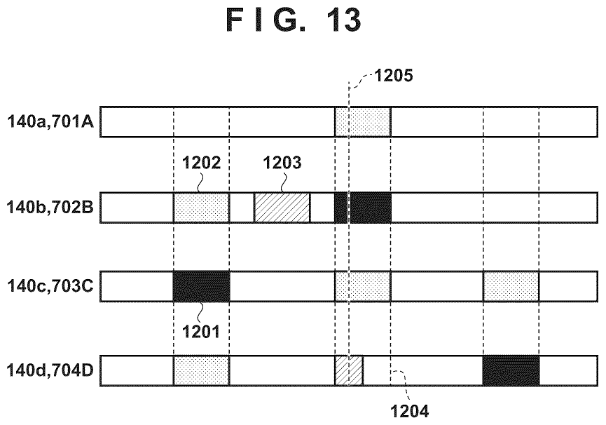

FIG. 13 is a diagram illustrating an example in which visual-quality evaluation values are recorded in temporal association with moving images shot by cameras.

Reference symbol 1201 indicates a high visual-quality evaluation value region including an image with a visual-quality evaluation value that is higher than or equal to the predetermined threshold and that is the best when visual-quality evaluation values are ranked. Reference symbol 1202 indicates a same subject detection region including an image in which the same subject as the primary subject in the high visual-quality evaluation value region 1201 is detected. Reference symbol 1203 indicates a high subject matching degree region in which the visual-quality evaluation value has fallen below the predetermined threshold but the subject matching degree is higher than or equal to the predetermined threshold. Reference symbols 1204 indicate moving-image segment dividers (so-called “sections” in video editing software), and reference symbol 1205 indicates the timepoint at which the images in FIG. 7 were shot by the cameras in the camera system.

### [Automatic Recording and Automatic Editing Using Data of Ranks of Visual-Quality Evaluation Values]

In live streaming, images are often edited as highlighted scenes and separately streamed after viewer streaming. Furthermore, in sports such as soccer where there are goals, there are cases in which an image for streaming a goal scene to viewers is shot using a separate camera and streamed as a highlighted scene immediately after a goal is scored. Thus, if the camera system can automatically detect a scene with good visual quality and automatically create a highlight-scene image by performing sectioning processing, user burden of creating highlight-scene images can be significantly alleviated or eliminated.

### [Automatic Recording of Visual-Quality Evaluation Values, and Automatic Section Setting]

A specific example in which the camera system automatically detects a scene with good visual quality and performs sectioning processing will be described with reference to FIG. 13.

The purpose of a highlight-scene video is to extract a scene with particularly good visual quality and deliver such a scene to viewers within a short duration. In doing so, there are cases in which it is desired that even an image that was not used streamed in consideration of the coherence of the streaming image in the time axis during live streaming be extracted as an option, provided that the emphasis is on visual quality within a short duration. Thus, it is desirable that an image extraction method be adopted in which such a purpose of use is also taken into consideration.

A method such as that below is conceivable as a specific measure for allowing the camera system to automatically detect a scene with good visual quality and perform sectioning processing. Images shot using the camera system and data of ranks of visual-quality evaluation values shared within the camera system are recorded in association with one another, and sectioning processing is also executed simultaneously in accordance with visual-quality evaluation value levels. This method makes it possible to automatically extract regions with high visual-quality evaluation values as exemplified by the high visual-quality evaluation value region 1201, as illustrated in FIG. 13. Thus, in a case in which the user creates a highlight video, important portions of videos can be segmented and displayed by highlighted display. The sectioning processing can be executed by setting the start and end points of a section by using as a trigger a change in ranks in the ranking of visual-quality evaluation values or whether or not a visual-quality evaluation value has exceeded the predetermined threshold.

In addition, by also associating and recording primary subject detection results in images (if necessary, detection results for all candidate subjects in images) together with the images during shooting, the primary subject detected in the high visual-quality evaluation value region 1201 can be automatically detected from images shot by other cameras at the same timepoint. Furthermore, this can be visualized as exemplified by the same subject detection regions 1202.

While a method for realizing automatic editing will be described in the present embodiment, in a case in which the user performs the editing, display of the content in FIG. 13 on an editing screen would make it possible to distinguish regions with high visual-quality evaluation values and regions with low visual-quality evaluation values. Furthermore, because sectioning processing is also applied, portions that are unnecessary for editing a highlight-scene video can be readily deleted. Thus, a function that is highly advantageous for the user would be obtained by merely displaying the content in FIG. 13. If the screen in FIG. 13 is to be shown to the user, the degree of highlighting is varied depending on the ranks of visual-quality evaluation values, and the boundaries of section regions and the method for filling section regions are varied depending on visual-quality evaluation value type. By taking such display-method-related measures, a UI that facilitates editing by the user can be provided.

### [Automatic Editing and Automatic Image Deletion]

In a case in which visual-quality evaluation values are recorded in association with shot images, largely two types of automatic editing methods in which the visual-quality evaluation values are used are conceivable. One is a method of extracting, at each timepoint, only an image shot by one camera, such as a method of automatically extracting and connecting only the high visual-quality evaluation value regions 1201 illustrated in FIG. 13. The other is a method of, if characteristic images such as a same subject detection region 1202, a high subject matching degree region 1203, etc., are detected besides a high visual-quality evaluation value region 1201, extracting all such images even if the images correspond to the same timepoint.

In the former method, a configuration may be adopted such that, in a case in which there are a plurality of types of visual-quality evaluation values, the plurality of visual-quality evaluation values are combined and integrated into a single visual-quality evaluation value, and the visual-quality evaluation value that is ranked highest when visual-quality evaluation values are ranked is extracted. Furthermore, a visual-quality evaluation value obtained by combining a plurality of visual-quality evaluation values may be calculated during shooting in the first place, and the visual-quality evaluation value may be recorded in association with each image in advance.

In the latter method, for each visual-quality evaluation value (visual-quality evaluation value based on subject posture estimation, visual-quality evaluation value based on subject matching degree, etc.), data obtained by ranking values is recorded in association with images at each timepoint. Furthermore, when automatic editing is performed, thresholds are set with respect to each visual-quality evaluation value and ranks within the visual-quality evaluation value to automatically extract and edit one or more images exceeding or equaling the thresholds. Thus, the user load for creating a highlight-scene video can be reduced.

This concludes the description of the automatic editing method; meanwhile, one function associated with automatic editing that would be needed by the user is the recorded-image automatic deletion function. Recent years have seen an increase in recorded image data amount due to an increase in the definition of recorded images brought about by an increase in the number of image sensor pixels. In particular, in a camera system, such as that of the present embodiment, that is expected to be used to shoot images over a long period of time using a plurality of cameras, the amount of image data recorded each time shooting is performed would be enormous. Thus, a function enabling unnecessary image data to be automatically deleted would be highly advantageous for the user. The recording, in recorded images, of visual-quality evaluation values associated with the recorded images makes it possible to automatically delete images with low visual-quality evaluation values. There are three specific types of methods that are conceivable.

In the first method, images with low visual-quality evaluation values are not recorded in the first place. This method is advantageous in that the camera system can be simplified because the recorded image volume during shooting can be reduced and the system load is reduced. On the other hand, there is a disadvantage that, even if an image with a high visual-quality evaluation value is suddenly shot, the image might not be recorded.

In the second method, if it is detected, after a shot image has been recorded and the automatic sectioning processing has been applied thereto, that the visual-quality evaluation value is ranked lower than the predetermined rank or that there is no time period during which the visual-quality evaluation value exceeded the predetermined threshold, the corresponding section(s) is/are deleted (method of performing deletion during shooting if the white sections in FIG. 13 are detected). This method is advantageous in that the recorded image data amount can be reduced without missing shooting opportunities. On the other hand, there is a disadvantage in that load is applied to the system during data deletion, and measures for improving system processing performance and measures against heat need to be taken.

In the third method, deletion is performed if input for deletion is received from the user after a round of shooting is completed. This method is advantageous in that the camera system can be simplified without missing shooting opportunities. On the other hand, there is a disadvantage in that a large image recording capacity would be necessary.

As described above, the three types of automatic deletion methods each have their own advantage and disadvantage; thus, it is desirable that a suitable method be adopted in accordance with the purpose of use of the camera system.

[Flowchart for Recording Visual-Quality Evaluation Values in Association with Images]

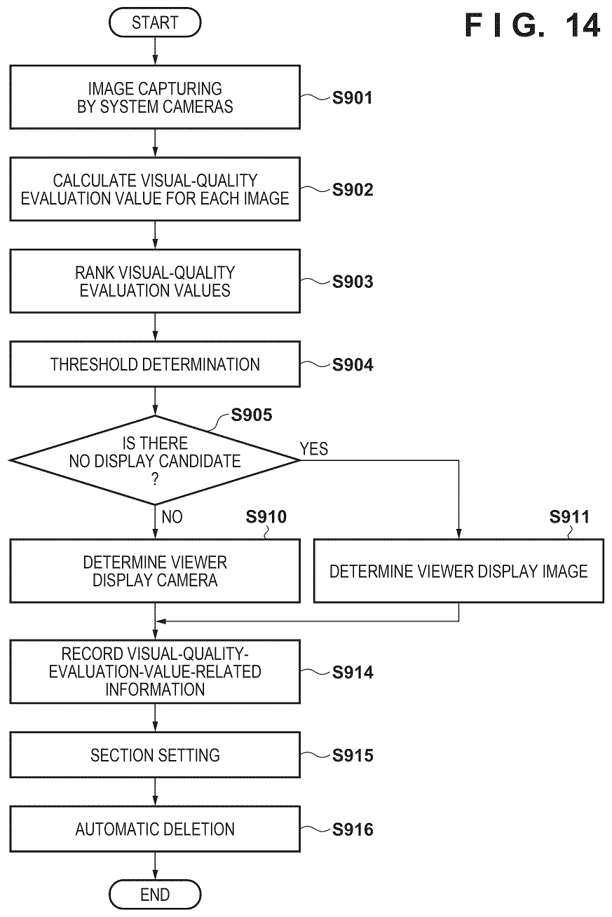

FIG. 14 is a flowchart illustrating an operation in the present embodiment for recording data obtained by ranking visual-quality evaluation values calculated in the camera system in association with images.

Steps S901 to S905, step S910, and step S911 are similar to those in FIG. 9B, and description thereof is thus omitted.

In step S914, the visual-quality-evaluation-value-related information that is recorded differs depending on whether the previous step is step S910 or step S911; thus, description is separately provided for these cases in the following.

First, description will be provided of a case in which the previous step is step S910. In this case, the rank of the corresponding visual-quality evaluation value and the visual-quality evaluation value are recorded in each image. As a specific example, a case of timepoint 1205 in FIG. 13 will be described.

According to FIG. 7, the visual-quality evaluation value of camera 2 (140b) is “78” and is ranked highest (first place) in the ranking of visual-quality evaluation values; thus, in the present embodiment, such information is recorded in association with image B702. Thus, as Exif information, the visual-quality evaluation value “78” and the rank “1” of the visual-quality evaluation value are recorded. In addition, in the present embodiment, image information of the primary subject 705 that will be necessary in automatic editing and information indicating that the image has been selected as the viewer streaming image are also recorded.

In regard to camera 1 (140a), the visual-quality evaluation value “64”, the rank “2” of the visual-quality evaluation value, the primary subject 705, and the primary subject 709 in image B702 are recorded as Exif in association with image A701.

In regard to camera 3 (140c), the visual-quality evaluation value “28”, the rank “3” of the visual-quality evaluation value, and the primary subject 705 are recorded as Exif in association with image C703.

In regard to camera 4 (140d), the visual-quality evaluation value “8”, the rank “4” of the visual-quality evaluation value, the primary subject 705, and the subject matching degree value are recorded as Exif in association with image D704.

In the third embodiment, the visual-quality evaluation value and the subject matching degree are independent visual-quality evaluation values, as is the case in the first embodiment; thus, if a visual-quality evaluation value and a subject matching degree value are each detected, the values are separately recorded in association with an image. However, in a case in which a single visual-quality evaluation value is calculated by combining a plurality of visual-quality evaluation values, the single visual-quality evaluation value may be recorded in association with an image.

Subsequently, description will be provided of a case in which the previous step is step S911. The basic content that is recorded is the same as that in the case in which the previous step is step S910; however, information indicating that the visual-quality evaluation values for all images were lower than the predetermined threshold is recorded as additional information. By recording this information in advance, processing for determining candidates to be automatically deleted can be simplified.

[Flowchart for Performing Automatic Editing Using Visual-Quality Evaluation Values Associated with Images]

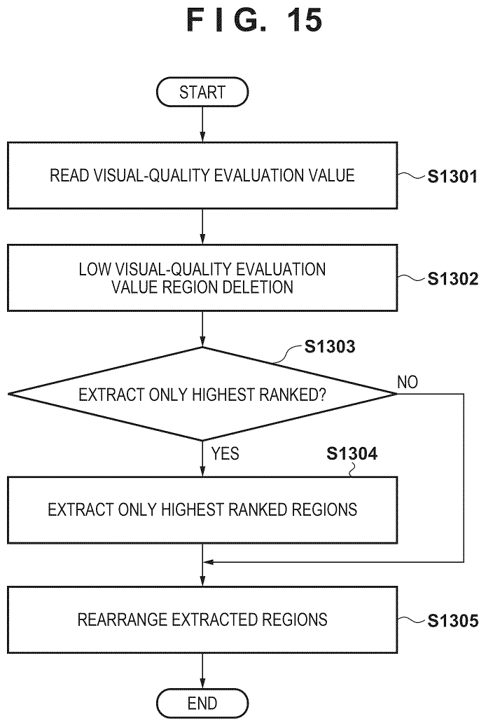

FIG. 15 is a flowchart illustrating an operation for automatically editing a highlight-scene video using the visual-quality evaluation values that have been recorded in association with the images in FIG. 14.

In step S1301, the CPU 121 reads the visual-quality-evaluation-value-related information recorded in association with the images. In the present embodiment, the visual-quality-evaluation-value-related information is read from Exif because the visual-quality-evaluation-value-related information is recorded in Exif of the images.

In step S1302, from the read visual-quality-evaluation-value-related information, the CPU 121 extracts and automatically deletes one or more images with visual-quality evaluation values lower than the predetermined threshold (in a case in which there are a plurality of visual-quality evaluation values, all of the visual-quality evaluation values are checked and one or more images for which all visual-quality evaluation values are lower than the predetermined thresholds are extracted and automatically deleted). Thus, processing can be simplified because there would be no unnecessary image data in rearrangement processing to be performed in step S1305 to create a highlight-scene video.

In the description above, description has been provided of an example in which images with visual-quality evaluation values lower than the predetermined threshold are automatically deleted. However, a configuration may be adopted in which images whose visual-quality evaluation values are ranked equal to or lower than a predetermined rank (if there are a plurality of visual-quality evaluation values, images for which all visual-quality evaluation values are ranked equal to or lower than the predetermined rank) are automatically deleted.

In step S1303, the CPU 121 determines whether or not to extract only images with visual-quality evaluation values ranked highest (first place in the present example), and advances processing to step S1304 if Yes and to step S1305 if No.

In step S1304, the CPU 121 extracts only image regions that are high visual-quality evaluation value regions.

In regard to step S1305, description is provided separately for a case in which the previous step is step S1304 and a case in which the previous step is step S1303.

In the case in which the previous step is step S1304, the extracted high visual-quality evaluation value regions, which are separated into sections, are basically rearranged and connected in chronological order to generate one highlight-scene video.

Describing this specifically with reference to FIG. 13, rearrangement is performed into the order of the high visual-quality evaluation value region 1201 shot using camera 3 (140c), the high visual-quality evaluation value region 1201 shot using camera 2 (140b), and the high visual-quality evaluation value region 1201 shot using camera 4 (140d) to generate one highlight video.

Next, in the case in which the previous step is step S1303, image regions overlapping temporally are extracted. In this case, basically, similarly to the case in which the previous step is step S1304, rearrangement in chronological order is performed on image regions separated into sections. If there are regions overlapping temporally, rearrangement is performed such that the region with a higher visual-quality evaluation value or a higher-ranked visual-quality evaluation value in the ranking of visual-quality evaluation values is prioritized over the other.

Describing this specifically with reference to FIG. 13, at timepoint 1205, rearrangement is performed into the order of the high visual-quality evaluation value region 1201 shot using camera 2 (140b), the same subject detection region 1202 shot using camera 1 (140a), the same subject detection region 1202 shot using camera 3 (140c), and the high subject matching degree region 1204 shot by camera 4 (140d).

According to the present embodiment described above, a highlight-scene video can be automatically created by performing automatic editing using visual-quality evaluation values associated with images. In the present embodiment, an example has been described in which automatic editing is realized by automatically extracting and rearranging highlight-scene video candidates. However, in accordance with user needs, a configuration may be adopted such that a result is displayed to the user at the stage when automatic extraction has been performed or at the stage when rearrangement has been performed so that the user can apply further editing.

As described above, automatic editing of a highlight video or the like can be performed by evaluating the visual quality of images shot by the plurality of cameras in the camera system and recording the visual quality as visual-quality evaluation values in association with the images.

According to the present disclosure, an image to be streamed to viewers can be automatically selected from among a plurality of images shot using different cameras.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus comprising:
at least one processor or circuit and a memory storing instructions to cause the at least one processor or circuit to perform operations of the following units:
a first acquiring unit configured to acquire a plurality of images respectively obtained by a plurality of image capturing devices;
a second acquiring unit configured to acquire, for each of the plurality of images, a visual-quality evaluation value indicating a degree of visual quality of the image; and
a selecting unit configured to select one or more candidate images from among the plurality of images based on the visual-quality evaluation value, the one or more candidate images each being a candidate of an image to be used for viewing.

2. The information processing apparatus according to claim 1, wherein the at least one processor or circuit is configured to further function as
a display controlling unit configured to display the one or more candidate images on a displaying device.

3. The information processing apparatus according to claim 2, wherein
the display controlling unit displays, on the displaying device, the one or more candidate images the visual-quality evaluation value of which is higher than or equal to a predetermined threshold.

4. The information processing apparatus according to claim 3, wherein the at least one processor or circuit is configured to further function as
a notifying unit configured to, in a case where there is no image the visual-quality evaluation value of which is higher than or equal to the predetermined threshold, provide a notification that there is no image the visual-quality evaluation value of which is higher than or equal to the predetermined threshold.

5. The information processing apparatus according to claim 2, wherein
among the one or more candidate images, the display controlling unit displays one or more candidate images the visual-quality evaluation value of which is higher than or equal to the predetermined threshold and one or more candidate images the visual-quality evaluation value of which is lower than the predetermined threshold on the displaying device so as to be distinguishable from one another.

6. The information processing apparatus according to claim 2, wherein
the second acquiring unit calculates the visual-quality evaluation value based on a degree of match of a subject in the image with a pre-registered image, and, among the one or more candidate images, the display controlling unit displays one or more candidate images having been selected based on the degree of match on the displaying device so as to be distinguishable from the other candidate images.

7. The information processing apparatus according to claim 2, wherein
together with the one or more candidate images, the display controlling unit displays a rank of the visual-quality evaluation value of each of the one or more candidate images.

8. The information processing apparatus according to claim 1, wherein the at least one processor or circuit is configured to further function as
an editing unit configured to edit the image to be used for viewing using the one or more candidate images.

9. The information processing apparatus according to claim 8, wherein
the editing unit selects an image having the highest visual-quality evaluation value from among the one or more candidate images to edit the image to be used for viewing.

10. The information processing apparatus according to claim 1, wherein
the second acquiring unit calculates the visual-quality evaluation value based on a posture of a subject in the image.

11. The information processing apparatus according to claim 1, wherein
the second acquiring unit calculates the visual-quality evaluation value based on a significance of a motion of a subject in the image in relation to a specific object.

12. The information processing apparatus according to claim 1, wherein
the second acquiring unit calculates the visual-quality evaluation value based on a degree of match of a subject in the image with a pre-registered image.

13. The information processing apparatus according to claim 1, wherein
the second acquiring unit calculates the visual-quality evaluation value based on at least one of: subject size in the image; a distance of a subject from a center of the image; an amount of change in subject position; and an amount of change in subject focal positions of subjects within a screen.

14. The information processing apparatus according to claim 1, wherein the at least one processor or circuit is configured to further function as
a controlling unit configured to control the plurality of image capturing devices based on the visual-quality evaluation value.

15. The information processing apparatus according to claim 14, wherein
the controlling unit adjusts at least one of a shooting direction, angle of view, focal position, aperture value, and exposure of the plurality of image capturing devices.

16. The information processing apparatus according to claim 14, wherein
the controlling unit controls the plurality of image capturing devices so that a first image capturing device that is one of the plurality of image capturing devices is used to perform telephoto shooting of a primary subject, and a second image capturing device that is different from the first image capturing device among the plurality of image capturing devices is used to perform wide-angle shooting so as to include an area other than the primary subject.

17. The information processing apparatus according to claim 14, wherein
in a case where there is no image the visual-quality evaluation value of which is higher than or equal to the predetermined threshold among the images obtained by the plurality of image capturing devices, the controlling unit causes at least one of the plurality of image capturing devices to perform automatic shooting based on a predetermined sequence.

18. The information processing apparatus according to claim 17, wherein
in the automatic shooting based on the predetermined sequence, shooting is performed of at least one of spectators, a bench, and a registered subject.

19. The information processing apparatus according to claim 1, wherein the at least one processor or circuit is configured to further function as
a recording unit configured to record the plurality of images chronologically together with the respective visual-quality evaluation values.

20. The information processing apparatus according to claim 19, wherein the at least one processor or circuit is configured to further function as
an editing unit configured to, based on the plurality of images recorded by the recording unit and the visual-quality evaluation values, select and edit one or more highlight scenes from the plurality of images.

21. The information processing apparatus according to claim 19, wherein the at least one processor or circuit is configured to further function as
a deleting unit configured to delete ones of the plurality of images the visual-quality evaluation values of which are lower than the predetermined threshold.

22. An information processing method comprising:
acquiring a plurality of images respectively obtained by a plurality of image capturing devices;
for each of the plurality of images, acquiring a visual-quality evaluation value indicating a degree of visual quality of the image; and
selecting one or more candidate images from among the plurality of images based on the visual-quality evaluation values, the one or more candidate images each being a candidate of an image to be used for viewing.

23. A computer-readable storage medium having stored therein program for causing a computer to execute an information processing method, the method comprising:
acquiring a plurality of images respectively obtained by a plurality of image capturing devices;
for each of the plurality of images, acquiring a visual-quality evaluation value indicating a degree of visual quality of the image; and
selecting one or more candidate images from among the plurality of images based on the visual-quality evaluation values, the one or more candidate images each being a candidate of an image to be used for viewing.

24. An information processing apparatus comprising:
at least one processor or circuit and a memory storing instructions to cause the at least one processor or circuit to perform operations of the following units:
a first acquiring unit configured to acquire a plurality of images respectively obtained by a plurality of image capturing devices;
a second acquiring unit configured to acquire, for each of the plurality of images, a visual-quality evaluation value indicating a degree of visual quality of the image; and
a selecting unit configured to select one or more images from the plurality of images based on the visual-quality evaluation values.
